(19) United States
(12) Patent Application Publication
(10) Pub. No.: US 2026/0253262 A1
(43) Pub. Date: Aug. 27, 2026

(54) HARMONIZED MULTI-LAYER TEXT-TO-IMAGE GENERATION WITH GENERATIVE PRIORS

(71) Applicant: ADOBE INC., SAN JOSE, CA (US)

(72) Inventors: Yusuf Dalva, Blacksburg, VA (US); Yijun Li, Seattle, WA (US); Qing Liu, Santa Clara, CA (US); Nanxuan Zhao, San Jose, CA (US); Jianming Zhang, Cupertino, CA (US); Zhe Lin, Clyde Hill, WA (US)

(21) Appl. No.: 19/062,280

(22) Filed: Feb. 25, 2025

(51) Int. Cl. G06T 11/00; G06N 3/0455

(52) U.S. Cl. CPC G06T 11/00; G06N 3/0455

(57) ABSTRACT

A method, apparatus, non-transitory computer readable medium, and system for generating a synthetic image includes obtaining a first prompt indicating a foreground object and a second prompt indicating a background scene. A first image generation model is configured to generate a foreground attention output based on the first prompt, wherein the foreground attention output represents the foreground object. In some cases, a second image generation model is configured to generate a blended attention output based on the first prompt and the second prompt, wherein the blended attention output represents the foreground object with the background scene. The foreground attention output and the blended attention output are combined to obtain a combined blended attention output. Subsequently, the second image generation model generates a synthetic blended image depicting the foreground object in the background scene based on the combined blended attention output.

### BACKGROUND

The following generally relates to machine learning, and more specifically to image generation using a machine learning model. Machine learning algorithms build a model based on sample data, known as training data, to make a prediction or a decision in response to an input without being explicitly programmed to do so. One area of application for machine learning is image generation.

For example, a machine learning model can be trained to predict features for an image in response to an input prompt, and then generate the image based on the predicted features. In some cases, the prompt can be used to perform complex image manipulation and compositing. Such image generation provides for a user to edit an image and generate an image with desired features and therefore makes image generation easier for a layperson.

### SUMMARY

The present disclosure describes systems and methods for image processing, more specifically to image generation. Embodiments of the present disclosure include an image processing apparatus configured to obtain an input text including an element and generate an output image. In some cases, the image generation model is configured to generate the output image with a foreground layer comprising transparency information and a background layer comprising color information. For example, the image processing apparatus is configured to enable harmonized image generation based on dynamic interaction between the foreground layer and the background layer.

A method, apparatus, and non-transitory computer readable medium for image processing are described. One or more aspects of the method, apparatus, and non-transitory computer readable medium include obtaining a first prompt indicating a foreground object and a second prompt indicating a background scene; generating, using a first image generation model, a foreground attention output based on the first prompt, wherein the foreground attention output represents the foreground object; generating, using a second image generation model, a blended attention output based on the first prompt and the second prompt, wherein the blended attention output represents the foreground object with the background scene; and generating, using the second image generation model, a synthetic blended image depicting the foreground object in the background scene based on the foreground attention output and the blended attention output.

A method, apparatus, and non-transitory computer readable medium for image processing are described. One or more aspects of the method, apparatus, and non-transitory computer readable medium include obtaining a first prompt indicating a foreground object and a second prompt indicating a background scene; generating foreground features representing the foreground object, background features representing the background scene, and blended features representing the foreground object in the background scene; generating, using an image generation model, a combined blended attention output based on the foreground features, the background features, and the blended features; and generating, using the image generation model, a synthetic blended image depicting the foreground object in the background scene based on the combined blended attention output.

An apparatus and system for image processing are described. One or more aspects of the apparatus and system include a memory component; a processing device coupled to the memory component, the processing device configured to perform operations comprising: obtaining a first prompt indicating a foreground object and a second prompt indicating a background scene; generating, using a first image generation model, a foreground attention output based on the first prompt, wherein the foreground attention output represents the foreground object; generating, using a second image generation model, a blended attention output based on the first prompt and the second prompt, wherein the blended attention output represents the foreground object with the background scene; combining the foreground attention output and the blended attention output to obtain a combined blended attention output; and generating, using the second image generation model, a synthetic blended image depicting the foreground object in the background scene based on the combined blended attention output.

### BRIEF DESCRIPTION OF THE DRAWINGS

FIG. 1 shows an example of an image processing system according to aspects of the present disclosure.

FIG. 2 shows an example of a method for generating a blended image according to aspects of the present disclosure.

FIG. 3 shows an example of a blended image generation process according to aspects of the present disclosure.

FIG. 4 shows an example of a blended image repositioning process according to aspects of the present disclosure.

FIG. 5 shows an example of a blended image generation framework according to aspects of the present disclosure.

FIG. 6 shows an example of a first image generation model according to aspects of the present disclosure.

FIG. 7 shows an example of a latent diffusion process according to aspects of the present disclosure.

FIG. 8 shows an example of a diffusion transformer architecture according to aspects of the present disclosure.

FIG. 9 shows an example of a U-Net architecture according to aspects of the present disclosure.

FIG. 10 shows an example of a denoising diffusion process according to aspects of the present disclosure.

FIG. 11 shows an example of a method for image processing according to aspects of the present disclosure.

FIG. 12 shows an example of an algorithm for extracting structure prior information according to aspects of the present disclosure.

FIG. 13 shows an example of an algorithm for extracting content confidence prior information according to aspects of the present disclosure.

FIG. 14 shows an example of an algorithm for attention blending according to aspects of the present disclosure.

FIG. 15 shows an example of a method of training the first image generation model.

FIG. 16 shows an example of a method of training a machine learning model according to aspects of the present disclosure.

FIG. 17 shows an example of a method of training a diffusion network according to aspects of the present disclosure.

FIG. 18 shows an example of a computing device according to aspects of the present disclosure.

FIG. 19 shows an example of an image processing apparatus according to aspects of the present disclosure.

FIG. 20 shows an example of a machine learning model according to aspects of the present disclosure.

### DETAILED DESCRIPTION

The present disclosure describes systems and methods for image processing, more specifically to image generation. Embodiments of the present disclosure include an image processing apparatus configured to obtain an input text including an element and generate an output image. In some cases, the image generation model is configured to generate the output image with a foreground layer comprising transparency information and a background layer comprising color information. For example, the image processing apparatus is configured to enable harmonized image generation based on dynamic interaction between the foreground layer and the background layer.

Existing image generation systems generate an image with a combined foreground and background, i.e., the foreground region and the background region in the image are not separated. In some cases, an additional neural network is used in the existing systems for the separation which results in increased use of computational resources. Additionally, in some cases, existing systems are unable to accurately segment the foreground and the background regions since the data distribution from the image generation and image segmentation is different.

Moreover, some existing image generation systems are unable to generate layered content (e.g., a layered image) which is used to depict transparency in an image. In some examples, an existing system encodes the transparency information into the latent manifold of the generation model. However, such systems generate a foreground layer and a background layer using a sequential approach which results in inconsistencies and lack of harmony between the foreground and the background. Additionally, such image generation systems require high computational resources for model training.

By contrast, embodiments of the present disclosure are configured to perform the image generation as a training-free process. In some cases, the image generation model of the present disclosure is configured to generate a synthetic image based on simultaneous generation of layered content of an image. Accordingly, by generating layered content simultaneously, embodiments of the present disclosure are able to achieve harmonization between the layers while incorporating layer transparency information.

The present disclosure describes systems and methods for image generation. Embodiments of the present disclosure include an image generation model configured to generate an image based on simultaneous generation of layered content which enables an interaction between a foreground layer and a background layer. In some cases, the image generation model generates an image with the foreground layer comprising color information and transparency information (i.e., RGBA format with RGB corresponding to color information and A corresponding to alpha or transparency information) and the background layer comprising color information (i.e., RGB format).

Embodiments of the present disclosure include an image processing apparatus based on a machine learning model configured to perform harmonization between the foreground layer and the background layer. In some cases, the machine learning model comprises a first image generation model configured to generate the foreground layer and a second image generation model configured to generate the background layer. In some cases, the harmonization is performed based on a cross-attention mask and a self-attention mask extracted from the first image generation model. For example, each of the cross-attention mask and the self-attention mask enable identification of relevant features for simultaneous generation of the foreground layer and the background layer.

Embodiments of the present disclosure include an image processing apparatus configured to perform an attention blending for increased harmonization between the foreground region and the background region of the generated image. In some cases, the attention blending process is based on the cross-attention mask and the self-attention mask extracted from the first image generation model. For example, the attention blending process is used to incorporate information from the foreground layer and the background layer at the attention level which provides for a dynamic interaction and adjustment to the generated image. In some examples, a composition of the generated image is controlled using the dynamic interaction and adjustment processes that are performed based on modifying a relationship between the elements of a scene.

An embodiment of the present disclosure includes an image generation model configured to generate a layered image. In some examples, the image generation model is configured to generate an image with two layers, i.e., a foreground (RGBA) layer and a background (RGB) layer. For example, the layered image is generated in a harmonized manner which provides for an interaction between the foreground layer and the background layer.

As described herein, an input prompt refers to input text that indicates an object. For example, the input prompt is a “a duck in a lake at daytime”. In some examples, the input prompt comprises a first prompt describing a foreground element such as “a duck” and a second prompt describing a background element such as “a lake, daytime”.

In some cases, an attention output refers to the result of an attention block of an image generation model. For example, an attention mechanism computes a weighted aggregation of input values based on attention scores. The mechanism uses query, key, and value vectors to determine the relevance of input elements, assigning weights to the values based on similarity between queries and keys. The weighted sum of the values forms the attention output, which emphasizes relevant information for the given query.

As used herein, the foreground attention output refers to the result of an attention mechanism based on the first prompt. In some cases, the foreground attention output is computed based on the query, key, and value vectors associated with the first prompt. Additionally, the blended attention output refers to the result of an attention mechanism based on the first prompt and the second prompt. In some cases, the blended attention output corresponds to the attention block output for the blended image.

In some cases, the combined blended attention output refers to a result of blending features obtained from the cross-attention layer and the self-attention layer of a transformer block in the denoising network of each of the first image generation model and the second image generation model. For instance, the combined blended attention output is generated based on a combination of the blended attention output, the foreground attention output, and a blending map, wherein the blending map is obtained based on the structure prior information and the content confidence prior information.

An embodiment of the present disclosure includes an image processing apparatus configured to perform an attention level “generative blending” process. Generative blending refers to exchanging intermediate attention outputs at one of more layers of multiple image generation models. In some cases, the attention level blending process is performs simultaneous blending of the foreground layer and the background layer based on a self-attention mask and a cross-attention mask, for example, the self-attention mask and the cross-attention mask that are extracted using the first image generation model.

Accordingly, embodiments of the present disclosure improve on conventional image generation systems by generating more accurate blended synthetic images. For example, the output images may have a more harmonized foreground element in a background scene. By performing simultaneous image generation that enables interactions between the foreground layer and the background layer, embodiments of the present disclosure are able to generate coherent and harmonized images and support flexible spatial edits for image manipulation. Additionally, by utilizing the cross-attention and self-attention masks from the first image generation model, embodiments provide for fine-grained control over the image generation process, which ensures that an element of the generated foreground and an element of the generated background interact to enhance the visual appeal and coherence of the generated image.

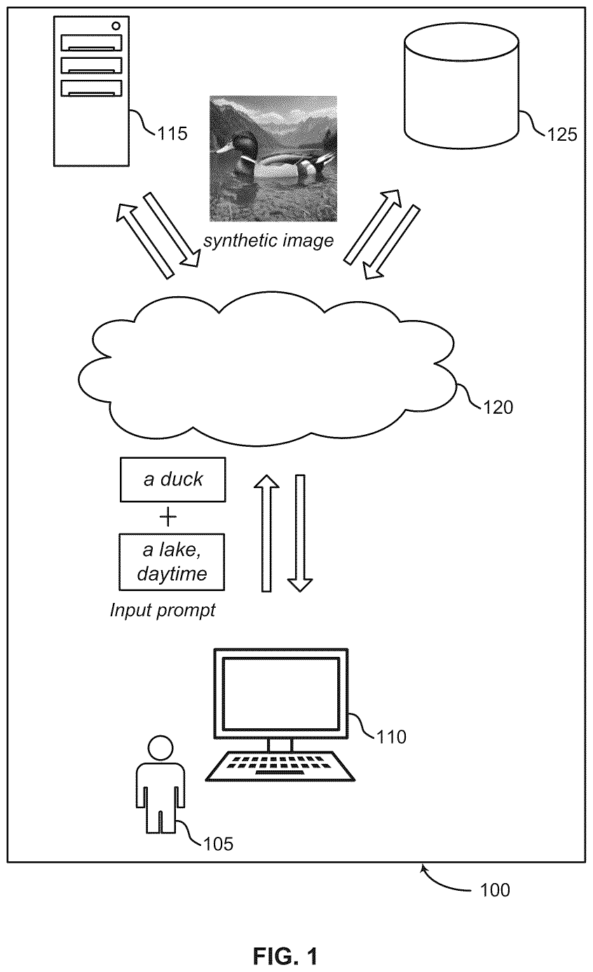

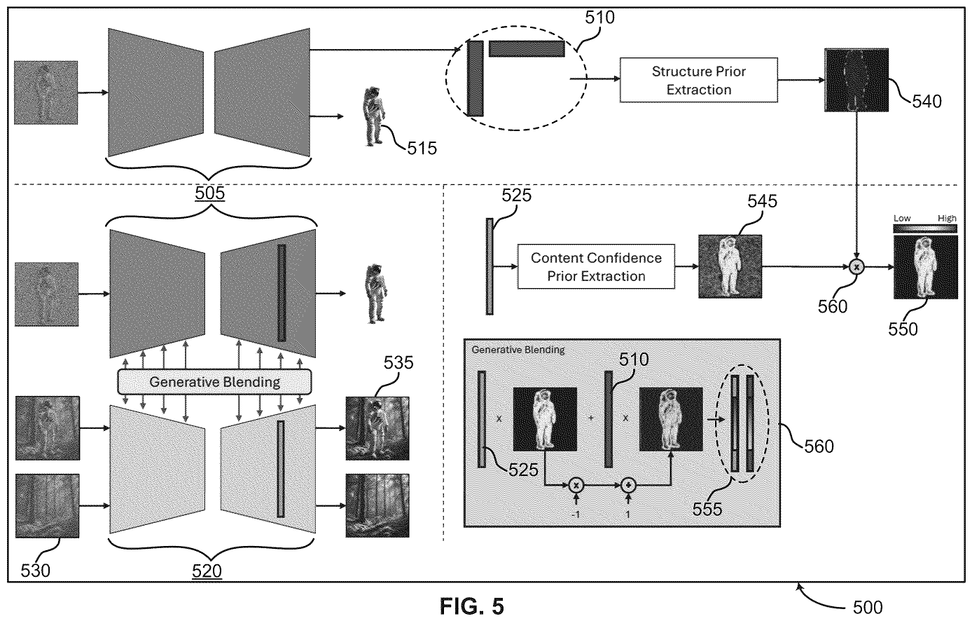

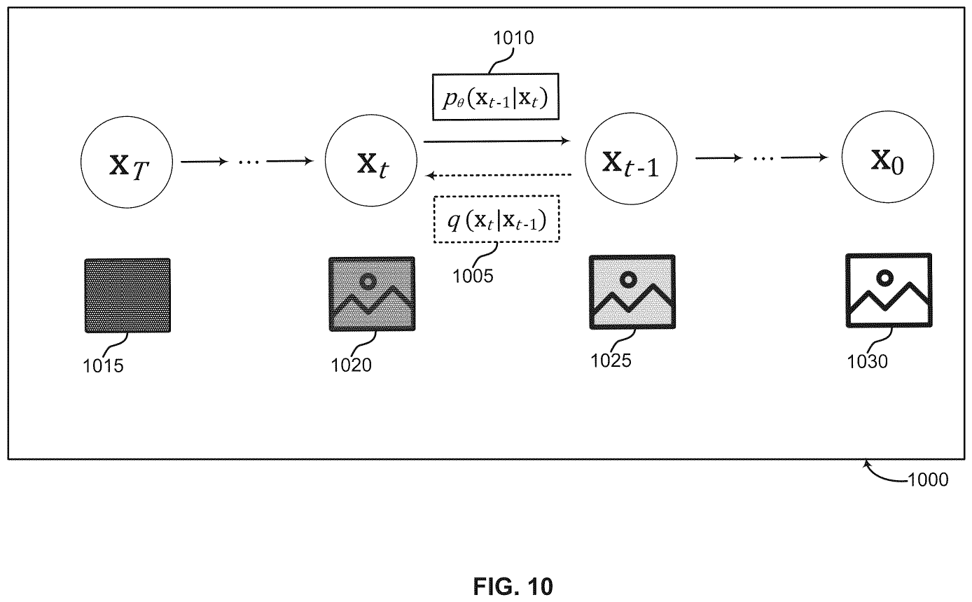

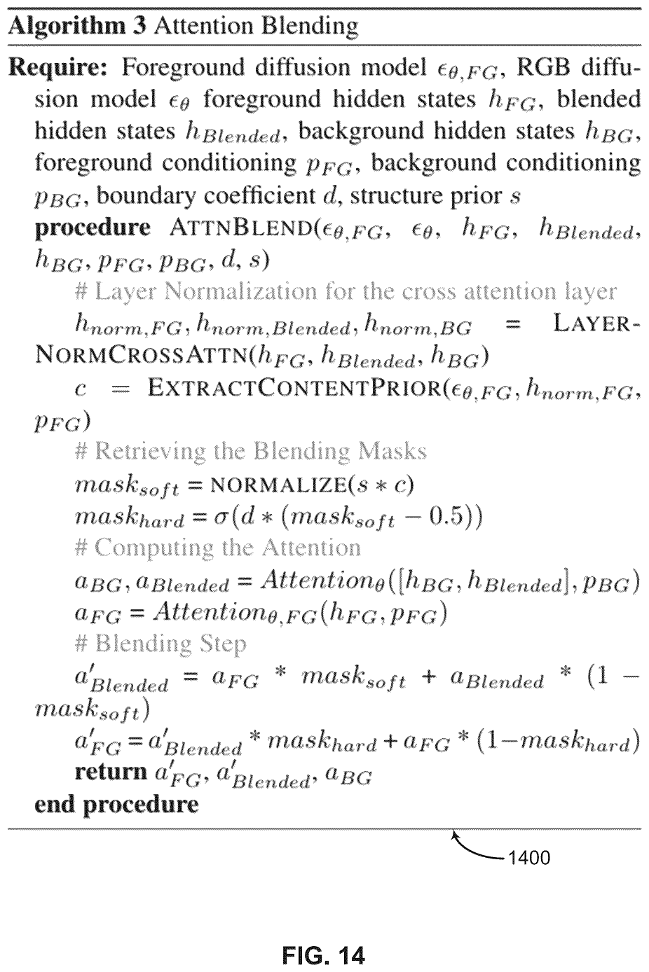

Embodiments of the present disclosure can be implemented in an image processing system. For example, the image processing system based on the present disclosure takes an input prompt (e.g., a foreground prompt describing a foreground element and a background prompt describing a background scene) and generates a synthetic image that accurately depicts the foreground element blended in the background scene. Example applications regarding generation of a synthetic image that depicts the blended foreground and background are provided with reference to FIGS. 1-4. Details regarding the architecture of the machine learning model comprising the first image generation model and the second image generation model are provided with reference to FIGS. 5-9 and 17-19. Details regarding an operation of the machine learning model are provided with reference to FIGS. 10-13. Examples of a process for training the machine learning model are provided with reference to FIGS. 14-16.

### Image Blending System

A system and an apparatus for image processing are described with reference to FIGS. 1-9. FIG. 1 shows an example of an image processing system 100 according to aspects of the present disclosure. In one aspect, image processing system 100 includes user 105, user device 110, image processing apparatus 115, cloud 120, and database 125.

In the example of FIG. 1, user 105 provides a foreground prompt describing a foreground element (e.g., a duck) to image processing apparatus 115 via a user interface provided on user device 110 by image processing apparatus 115. Additionally, in the example of FIG. 1, user 105 provides a background prompt describing a background scene (e.g., a lake, daytime) to image processing apparatus 115 via a user interface provided on user device 110 by image processing apparatus 115.

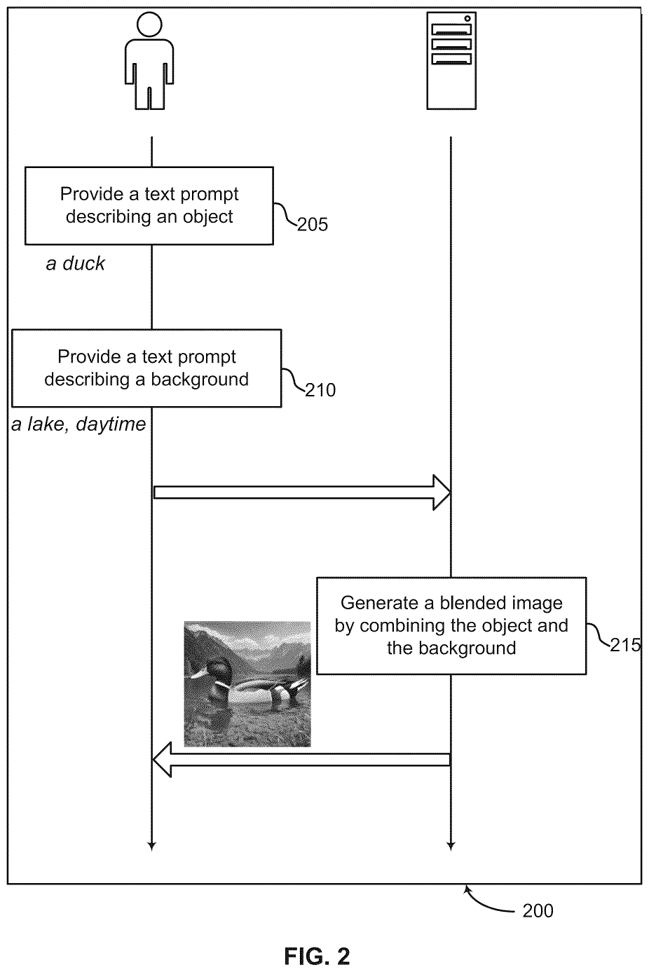

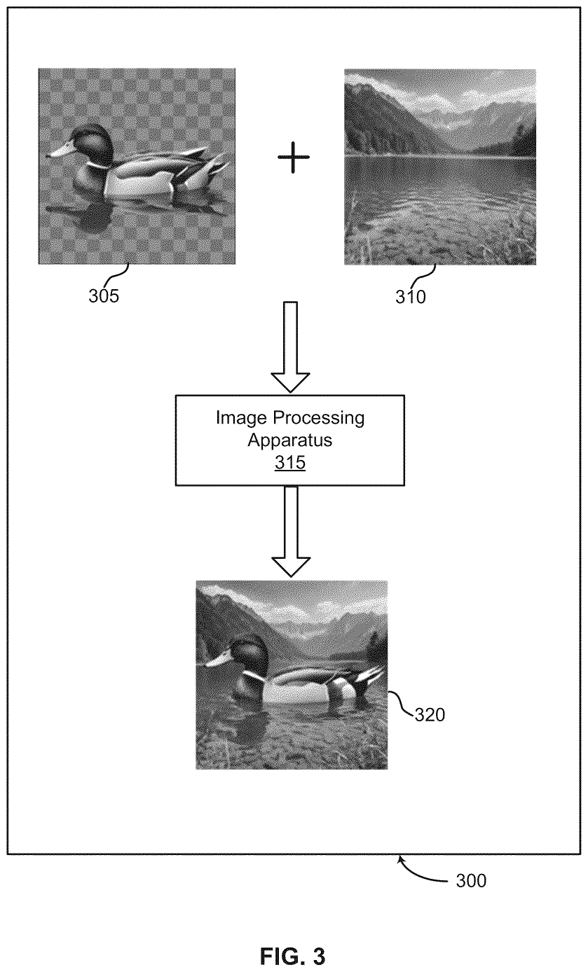

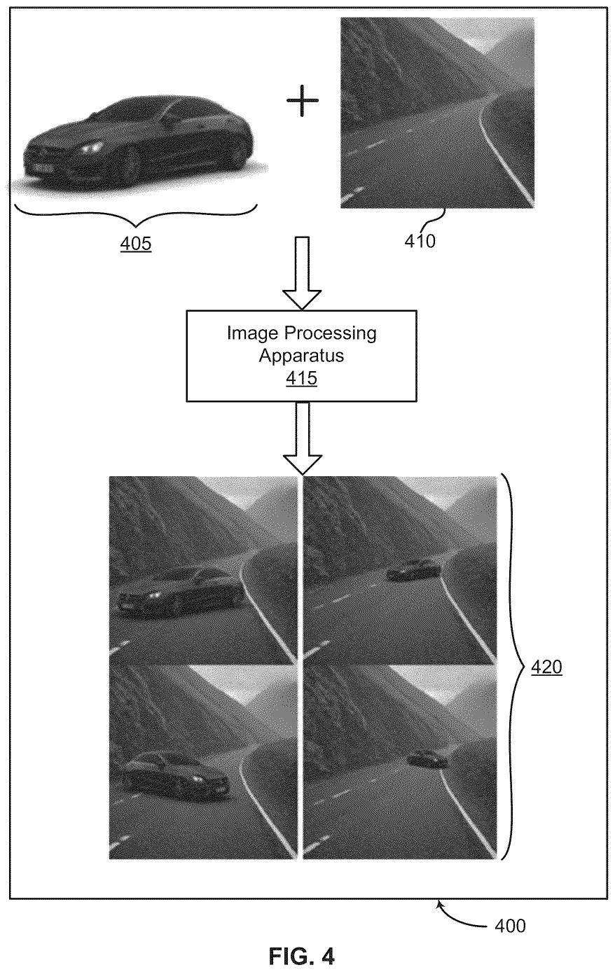

In some examples, each of the foreground prompt and the background prompt is an input text (such as shown in FIGS. 1-2). In some examples, the input prompt is an input image (such as shown in FIGS. 3-4). As shown in FIG. 1, the input prompt is a text that provides details on a foreground element and a background (e.g., “a duck” and “a lake, daytime”) based on which the user wants to generate a synthetic image using the image processing apparatus 115 of the present disclosure.

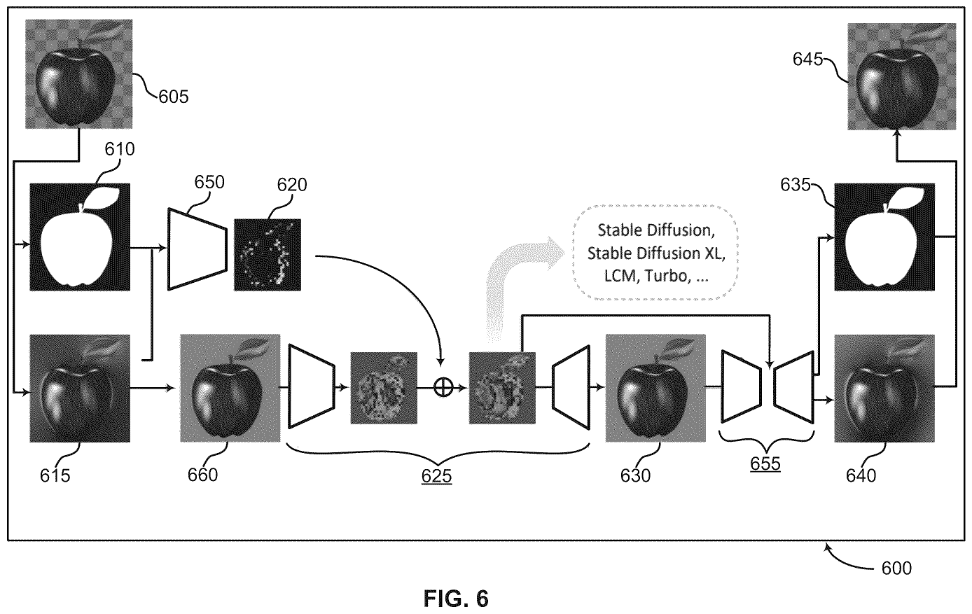

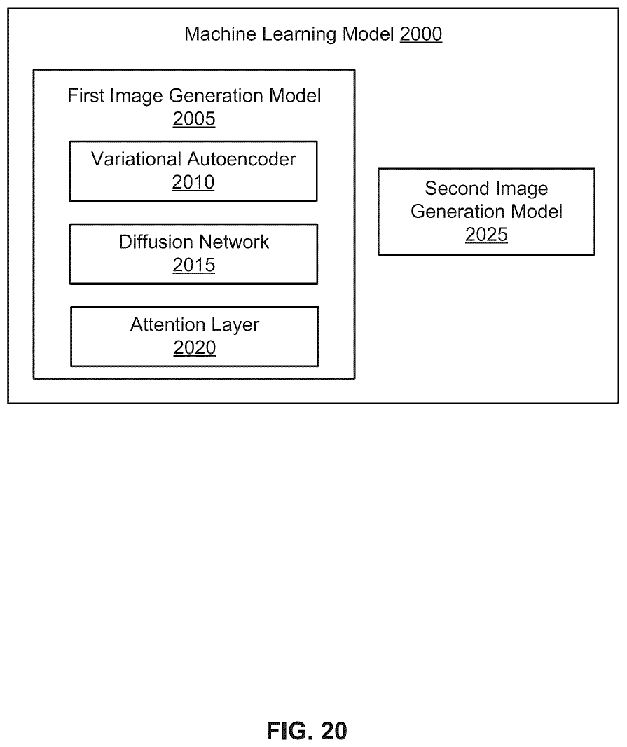

In some cases, the image processing apparatus 115 implements a machine learning model (such as the machine learning model comprising the first image generation model and the second machine learning model described with reference to FIGS. 5-6, and the first image generation model 2005 and the second machine learning model 2025 described with reference to FIG. 20) to generate a synthetic image that is based on the input prompt. In some cases, as shown in FIG. 1, the user 105 provides an input query (e.g., a text prompt) to the image processing apparatus 115, aspects of which the user wants to depict in the synthetic image. In some examples, the image processing apparatus 115 generates a synthetic image that accurately aligns with the information provided by the input query.

Referring again to the example of FIG. 1, the image processing apparatus 115 generates the synthetic image that accurately depicts an aspect (e.g., a foreground element and a background scene) described by the input query. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by image processing apparatus 115. In some aspects, the user interface provides for information (such as images (custom images or synthetic image), a prompt, etc.) to be communicated between user 105 and image processing apparatus 115. Image processing apparatus 115 is an example of, or includes aspects of, the corresponding element described with reference to FIGS. 3 and 4.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

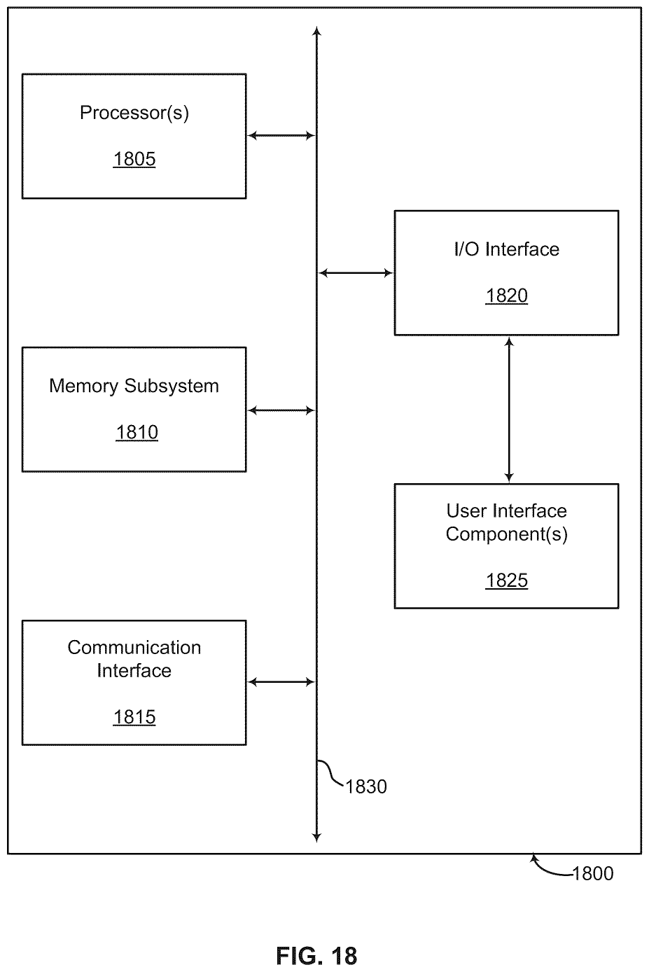

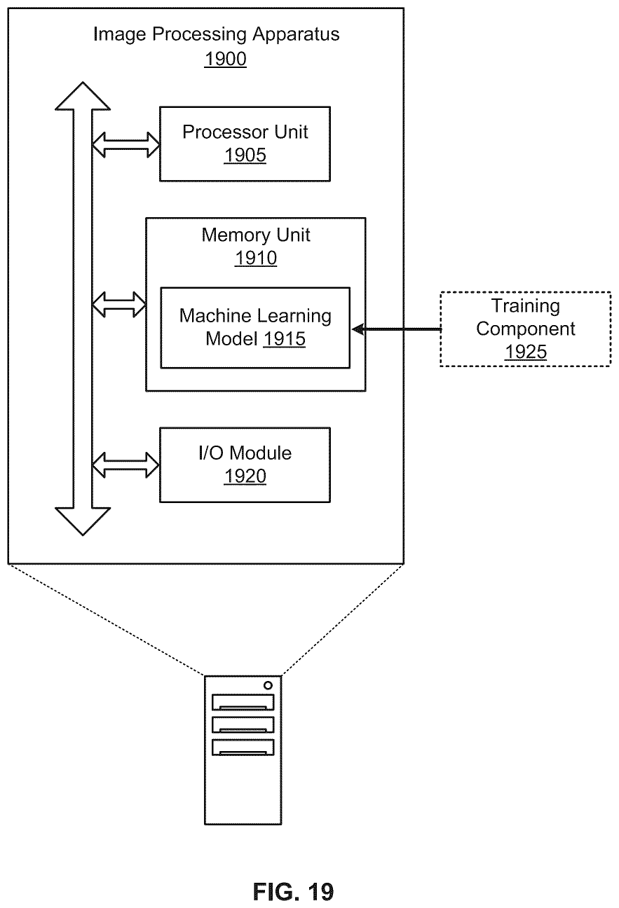

According to some aspects, image processing apparatus 115 includes a computer-implemented network. In some embodiments, the computer-implemented network includes a machine learning model (such as the machine learning model described with reference to at least FIGS. 18-19). In some embodiments, image processing apparatus 115 also includes one or more processors, a memory subsystem, a communication interface, an I/O interface, one or more user interface components, and a bus as described with reference to FIG. 14. Additionally, in some embodiments, image processing apparatus 115 communicates with user device 110 and database 125 via cloud 120.

In some cases, image processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, image processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to image processing apparatus 115 and communicates with image processing apparatus 115 via cloud 120. According to some aspects, database 125 is included in image processing apparatus 115.

FIG. 1 shows an example of a method 200 for generating a blended image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment of the present disclosure, an image processing apparatus (such as the image processing apparatus described with reference to FIGS. 3 and 18) provides a machine learning model (such as the machine learning model described with reference to FIGS. 18-19) that accurately generates a synthetic image depicting the foreground element and the background scene described in the input query.

At operation 205, the system provides a text prompt describing an object. In some cases, the operations of this step refer to, or may be performed by, a user as described with reference to FIG. 1. In some cases, the text prompt provides a foreground element based on which the user wants to generate an image. For example, the user provides a text prompt instructing the image processing apparatus to generate an image that accurately aligns with the text prompt.

At operation 210, the system provides a text prompt describing a background. In some cases, the operations of this step refer to, or may be performed by, a user as described with reference to FIG. 1. In some cases, the text prompt provides a background scene based on which the user wants to generate an image. For example, the user provides a text prompt instructing the image processing apparatus to generate an image that accurately aligns with the text prompt.

At operation 215, the system generates a blended image by combining the object and the background. In some cases, the operations of this step refer to, or may be performed by, an image processing apparatus as described with reference to FIG. 18.

In some cases, the image processing apparatus includes a machine learning model comprising a first image generation model (such as the first image generation model described with reference to at least FIGS. 5-6, 14, and 19) and a second image generation model (such as the second image generation model described with reference to at least FIGS. 5 and 19) that is configured to generate a blended image by combining the foreground object and the background scene.

According to an example, a foreground object that is blended with the background scene refers to an element that is consistent in certain aspects with the remaining aspects of the image. For example, the element is considered blended with the background scene when the element is consistent in lighting, consistent in pose, consistent in orientation, consistent in size, consistent in relationship with the background (i.e., remaining image). However, embodiments are not limited thereto, and blending of an element in an image may include any other aspect that makes an element in sync with the image. In some examples, an element is considered blended in an image when the element seamlessly harmonizes with the surrounding elements in terms of visual characteristics such as color, lighting, texture, etc. The process of blending ensures that the added or altered element appears as a natural part of the image rather than standing out as an incongruent element.

According to an embodiment of the present disclosure, the machine learning model comprises a first image generation model and a second image generation model, each based on a latent diffusion network. In some cases, the first image generation model is configured to generate a harmonized foreground (RGBA) layer. Additionally, in some cases, the second image generation model is configured to generate a background (i.e., RGB) layer. As such, the machine learning model is able to generate an image with two distinct layers, i.e., a foreground layer and a background layer.

In some examples, the blending operation performed between the foreground layer and the background layer relies on the quality of a cross-attention mask and a self-attention mask extracted from the first image generation model. The machine learning model comprises the first image generation model and the second image generation model, where each of the first image generation model and the second image generation model are based on a pre-trained latent diffusion network (such as described with reference to at least FIGS. 6-9 and 19) configured to generate the foreground and the background, respectively.

According to an embodiment, the image processing apparatus is configured to combine the foreground and the background to generate the blended image (combined using processes described with reference to FIG. 5). For example, as shown in FIG. 2, the image processing apparatus generates a blended image depicting “a duck” on “a lake, daytime” as stated in the prompts obtained at operation 205 and operation 210. The blended image is provided to the user via a user interface of the user device.

FIG. 3 shows an example of a blended image generation process 300 according to aspects of the present disclosure. In one aspect, blended image generation process 300 includes input object 305, input background 310, image processing apparatus 315, and blended image 320.

Referring to FIG. 3, input object 305 depicts an image of an object, i.e., “a duck” on a random background. For example, the user wants to replace a background of the input object 305. In some examples, the user provides input object 305 to image processing apparatus 315 via a user interface of the image processing apparatus 315. Input object 305 is an example of, or includes aspects of, the corresponding element described with reference to FIGS. 1-2 and 4.

Referring again to FIG. 3, input background 310 depicts an image of a background scene, i.e., “a lake, daytime”. For example, the user wants to incorporate the input object 305 into the input background 310. In some examples, the user provides input background 310 to image processing apparatus 315 via a user interface of the image processing apparatus 315. Input background 310 is an example of, or includes aspects of, the corresponding element described with reference to FIGS. 1-2 and 4.

The image processing apparatus 315 (such as the image processing apparatus described with reference to at least FIGS. 1-2 and 18) of the present disclosure receives input object 305 from the user. Additionally, the image processing apparatus 315 receives input background 310 from the user. In some cases, the image processing apparatus 315 comprises a machine learning model (such as the machine learning model 2000 described with reference to FIG. 20) that is configured to generate a blended image 320 based on the input object 305 and input background 310.

According to an embodiment of the present disclosure, the image processing apparatus 315 is configured to generate an image triplet comprising a foreground image (such as foreground object 305), a background image (such as background scene 310), and a blended image (such as blended image 320), wherein the images are combined in a realistic manner. In some cases, the first image generation model (such as first image generation model described with reference to FIGS. 5-9, 14, and 19) is used for generation of the foreground object 305. In some cases, the second image generation model (such as second image generation model described with reference to FIGS. 5, 7-9, and 19) is used for generation of the background scene 310 and the blended image 320.

In some cases, the second image generation model is configured to combine the information of the foreground object 305 and background scene 310 to generate the blended image 320 that represents the image details from the foreground object 305 and the background scene 310. The second image generation model generates an image triplet using a prompt for the foreground and a prompt for the background with a single iterative denoising process.

In some cases, the image processing apparatus 315 comprises a variational autoencoder network (such as variational autoencoder described with reference to FIG. 19) and a latent diffusion network (such as the latent diffusion network described with reference to FIGS. 6-9 and 19) that is configured to perform a blending operation for harmonization of the foreground object and the background scene. Image processing apparatus 315 is an example of, or includes aspects of, the corresponding element described with reference to FIGS. 1 and 4.

In some cases, by introducing an optimization-free blending approach that targets the attention layers, embodiments of the present disclosure enable an interaction mechanism between the image layers (i.e., foreground element and background scene) to achieve harmonization during blending. Additionally, by implementing a harmonized image generation method, embodiments of the present disclosure enable a dynamic interaction between the image layers to obtain a coherent blended image.

Referring to FIG. 3, blended image 320 accurately depicts the duck in the background scene of the lake. In some cases, the second image generation model is configured to perform a soft attention blending operation between a blended attention output (such as blended attention output described with reference to FIGS. 5 and 10) and a foreground attention output (such as foreground attention output described with reference to FIGS. 5 and 10) which reflects the foreground content on the blended image.

In some cases, the image processing apparatus is configured to perform a generative blending operation. For example, by performing the generative blending operation, embodiments of the present disclosure are able to generate visually appealing images by handling subtle elements such as shadows and lighting, which ensures the generated image depicts a foreground element that appears natural and harmonized with the background scene.

FIG. 4 shows an example of a blended image repositioning process 400 according to aspects of the present disclosure. In one aspect, blended image repositioning process 400 includes input object 405, input background 410, image processing apparatus 415, and repositioned blended images 420.

Referring to FIG. 4, input object 405 depicts an image of an object, i.e., “a car”. For example, the user wants to include a background of the input object 405. In some examples, the user provides input object 405 to image processing apparatus 415 via a user interface of the image processing apparatus 415. Input object 405 is an example of, or includes aspects of, the corresponding element described with reference to FIG. 3.

Referring again to FIG. 4, input background 410 depicts an image of a background scene, i.e., “a road”. For example, the user wants to incorporate the input object 405 into the input background 410. In some examples, the user provides input background 410 to image processing apparatus 415 via a user interface of the image processing apparatus 415. Input background 410 is an example of, or includes aspects of, the corresponding element described with reference to FIG. 3.

The image processing apparatus 415 comprises a first image generation model (such as the first image generation model described with reference to FIGS. 5-9, 14, and 19) and a second image generation model (such as the second image generation model described with reference to FIGS. 5, 7-9, and 19) that are each based on a latent diffusion model. According to an example, the image processing apparatus achieves harmonious blending and depicts smooth foreground and background images.

According to an exemplary embodiment of the present disclosure, the harmonious blending of the foreground and the background is achieved based on simultaneous generation of the foreground image and the background image. For example, the simultaneous image generation results in precise foreground for the cases that include an interaction between foreground layer and the background layer. In some examples, an attention mask is used to control an interaction between the foreground layer and the background layer.

Accordingly, the image processing apparatus implements a layered representation. By implementing the layered representations, embodiments of the present disclosure enable performing of straight-forward spatial editing with the generated image layers. Additionally, since the foreground element and the background scene are harmonized and are present at different layers (i.e., foreground layer and background layer), a user is able to easily reposition and rescale foreground object 405 on the background scene 410 to obtain repositioned blended images 420. Image processing apparatus 415 is an example of, or includes aspects of, the corresponding element described with reference to FIGS. 1 and 3.

FIG. 5 shows an example of a blended image generation framework 500 according to aspects of the present disclosure. In one aspect, blended image generation framework 500 includes first image generation model 505, foreground attention output 510, foreground object 515, second image generation model 520, blended attention output 525, background scene 530, synthetic blended image 535, structure prior information 540, blended content confidence information 545, blended mask 550, combined blended attention output 555, and blending operation 560.

The present disclosure describes systems and methods for image generation. Embodiments of the present disclosure include the first image generation model for generation of the foreground element. In some cases, the first image generation model 505 (such as first image generation model 600 described with reference to FIG. 6) is able to achieve foreground transparency based on implementing a latent transparency offset xₑ. First image generation model 505 is an example of, or includes aspects of, the corresponding element described with reference to FIG. 6.

In some cases, the latent transparency offset x_{∈} is used to adjust the latent x decoded by a variational autoencoder (VAE) (such as the variational autoencoder 2010 described with reference to FIG. 20) to obtain a latent distribution modelling a foreground object as xₐ=x+x_{∈}. Further details regarding obtaining the latent distribution are provided with reference to FIG. 6. Further details regarding the latent transparency offset are provided with reference to FIGS. 6 and 14.

In some cases, the image processing apparatus is configured to train a transparent VAE D (Î,xₐ). In some cases, the trained transparent VAE is used to predict the alpha (α) channel of a RGB image that includes a (e.g., a single) foreground image (such as foreground image object 515) referred to as the pre-multiplied image Î (such as the pre-multiplied image described with reference to FIG. 6).

The image processing apparatus of the present disclosure is configured to generate a blended image and a background image. In some cases, the image generation model is a training-free model that is used to generate synthetic blended image 535 and the background image. For example, the background image depicts a background scene 530. For example, the image processing apparatus is configured to ensure a uniform output distribution of the first image generation model 505. Background scene 530 is an example of, or includes aspects of, the corresponding element described with reference to FIGS. 3-4 and 14.

Embodiments of the present disclosure are configured to perform attention level blending to obtain a harmonized foreground and background region in the generated image. In some cases, the attention level blending process combines an attention output with a mask. In some cases, by combining the attention outputs with a mask, embodiments of the present disclosure are able to provide sufficient information on the content and structure of the foreground latent being diffused.

According to an embodiment of the present disclosure, the image processing apparatus utilizes a self-attention probability map and a cross-attention probability map of the first (i.e., foreground) image generation model 505 as a structure information and a content prior information for the generative process, respectively. Each of the probability maps (e.g., foreground attention output 510) are formulated as

$$softmax ( \frac{Q \cdot {K}^{T}}{\sqrt{d}} ) ,$$

where Q and K are query features and key features of the respective attention layer.

In some cases, the image processing apparatus includes first image generation model 505 and second image generation model 520 that operate interactively based on a training-free process. In some cases, the second image generation model 520 is configured to bound a blending region (such as blended attention output 525) with a structure prior (such as structure prior information 540) extracted from the first image generation model (∈_{θ,FG}) 505 during the blending process. As shown in FIG. 5, each attention layer of the second image generation model 520 comprises a connection to a corresponding attention layer of the first image generation model 505 to enable a blending operation. By incorporating the connections between the first image generation model and the second image generation model, embodiments of the present disclosure are able to enable information exchange between the first image generation model and the second image generation model.

An embodiment of the present disclosure is configured to perform an extraction of the structure prior information. In some cases, the first image generation model 505 is configured to extract structure prior information 540 by performing a prior pass based on the self-attention layer. The attention probability map m∈ [symbol] ^{M×M} of the corresponding self-attention layer is averaged over the attention heads to extract a boundary for the foreground generated by the first image generation model (∈_{θ,FG}) 505. In some cases, the last dimension of the probability map implies a probability distribution of the cross correlation values between a variable and each of the other variables processed by the self-attention layer, where M is the number of variables processed by each attention block.

In some cases, the density of the distribution of the cross-correlation values of a variable is used to identify the variable as a foreground. In some examples, the first image generation model (∈_{θ,FG}) 505 is trained to generate a single element as the foreground object (such as a foreground object 515). For example, the first image generation model 505 computes a per-variable sparsity score

$${s}_{i} = \frac{1}{{\sum }_{j = 1}^{M} {m}_{i , j}^{2}} ,$$

where sᵢ is the sparsity score for variable i, followed by a min-max normalization. In some examples, since the score sᵢ measures the sparsity of the cross-correlation value distribution of the variable i, the density estimate is obtained using

$${s}_{i}^{′} = 1 - normalize ( {s}_{i} )$$

(i.e., using a dense probability distribution instead of a sparse probability distribution).

In some cases, the structure information of a preceding layer of the first image generation model 505 is captured based on the sparsity estimate sᵢ for variable i. In some cases, the last self-attention layer of the diffusion model (i.e., first image generation model 505 implemented using a diffusion model as described with reference to at least FIGS. 6 and 19) captures the structure prior information (as depicted using structure prior information 540). For example, the structure prior information 540 extracted from the last self-attention layer provides a precise estimate of the shape of the foreground being generated.

The second image generation model 520 of the present disclosure is configured to extract content confidence prior information (such as blended content confidence information 545) as an attention map. In some cases, the extracted content confidence prior information (e.g., blended content confidence information 545) is used to perform blending of the background (such as background scene 530) and foreground (such as foreground object 515). In some cases, a cross-attention map of a transformer layer of the second image generation model 520 is used for the blending operation 560.

According to an example, the first image generation model 505 extracts a content confidence map from <EOS> attention probability map based on a unidirectional nature of an encoder (e.g., CLIP text encoder). In some examples, the extracted content confidence map is used to accumulate information related to the foreground object 515. Additionally, the first image generation model (∈_{θ,FG}) 505 is used to extract the foreground related information (i.e., the first image generation model (∈_{θ,FG}) is conditioned on generating a single foreground element, i.e., foreground object 515).

The second image generation model 520 is configured to utilize a cross-attention probability value n∈ [symbol] ^{H×M×T} of a conditional estimate, conditioned by a foreground prompt (such as a foreground prompt described with reference to FIGS. 1-2), where the cross-attention layer has H heads, and T is the number of text tokens input. In some cases, the second image generation model 520 is configured to extract a soft content confidence map c based on the probability maps. In some cases, the extracted soft content confidence map is used to quantify an influence of the input prompt on the generated foreground (e.g., foreground object 515). In some cases, the quantification is obtained based on a mean of the cross-attention probability maps over H attention heads.

According to an embodiment, the second image generation model 520 is configured to perform a blending operation 560 for harmonization of the foreground region (such as foreground object 515) and the background region (such as the background scene 530). In some cases, the harmonization is achieved based on formulation of the structure prior information 540 and the content confidence maps (such as a foreground content confidence information) extracted from the first image generation model (∈_{θ,FG}). In some cases, the blending operation 560 incorporates details from the self-attention maps and the cross-attention maps based on the generative priors extracted from a targeted layer. For example, the blending operation 560 is implemented to incorporate content generated gradually at each consecutive attention layer. In some examples, the self-attention layer focuses on the structure details and the cross-attention layer focuses on the content of the image.

In some cases, the second image generation model 520 implements a mask extraction algorithm for the blending operation 560. In some cases, the mask extraction algorithm is configured to extract a soft blending mask and a hard blending mask for a given attention block. For example, the second image generation model 520 is configured to extract a soft mask mask_{soft} as s*c followed performing by a min-max normalization for use as a blending mask (such as blended mask 550), where s corresponds to the structure prior information 540 and c corresponds to the content confidence prior information (such as blended content confidence information 545).

In some cases, the second image generation model 520 is configured to extract a hard mask mask_{hard} to identify a region that is affected by the soft blending. In some cases, the hard mask is extracted using the soft decision boundary σ (d*(mask_{soft}−0.5)), where σ is the sigmoid operator. In some examples, d refers to a decision boundary coefficient (e.g., d=10).

The second image generation model 520 is configured to perform an attention level blending operation based on the extracted soft blending mask and the hard blending mask. For example, the blending operation 560 includes an attention output of the blended image (a_{Blended}) (such as blended attention output 525) and an attention output of the foreground image (a_{FG}) (such as foreground attention output 510). In some examples, the second image generation model 520 is configured to generate an image triplet comprising the foreground image, the background image, and the blending image.

In some cases, the soft mask mask_{soft} encodes the structure information (such as structure prior information 540) and content information (such as a foreground content confidence information) related to the foreground. In some cases, the second image generation model 520 is configured to perform a soft attention blending operation between the blended attention output 525 and the foreground attention output 510 to generate a combined blended attention output 555 which reflects the foreground content on the blended image. The blending operation is performed as:

$${a}_{Blended}^{′} = {a}_{F G} * {mask}_{soft} + {a}_{B l e n d e d} * ( 1 - {mask}_{soft} ) \qquad ( 1 )$$

Subsequently, the second image generation model 520 updates the attention output for the foreground image comprising the blending result with the hard mask mask_{hard}.

$${a}_{FG}^{′} = {a}_{Blended}^{′} * {mask}_{h a r d} + {a}_{F G} * ( 1 - {mask}_{h a r d} ) \qquad ( 2 )$$

Accordingly, by updating the attention output for the foreground image with the hard mask, embodiments of the present disclosure are able to ensure consistency across the blended image and the foreground image. In some cases, first image generation model 505 and second image generation model 520 operate interactively based on a training-free process. For instance, embodiments are able to perform information transfer between the second image generation model (∈_{θ}) 520 and the first image generation model (∈_{θ,FG}) 505 at each attention layer associated with the first image generation model 505 and second image generation model 520.

The second image generation model 520 is configured to generate an image triplet based on an attention sharing mechanism between a blended hidden state and a background hidden state. Accordingly, by performing an attention sharing between the hidden states, embodiments of the present disclosure are able to generate an image (e.g., synthetic blended image 535) that depicts a background consistent with the blended image for the self-attention block and the cross-attention block. As used herein,

$${a}_{Blended}^{′} , {a}_{FG}^{′} ,$$

and a_{BG} refer to the attention outputs associated with the blended image, foreground image, and background image, respectively.

FIG. 6 shows an example of a first image generation model according to aspects of the present disclosure. First image generation model 600 is an example of, or includes aspects of, the corresponding element described with reference to FIGS. 5, 14, and 19.

In one aspect, first image generation model 600 includes transparent image 605, alpha channel 610, color channel 615, latent transparency 620, diffusion network 625, decoded pre-multiplied image 630, decoded alpha channel 635, decoded color channel 640, synthetic image 645, trainable encoder 650, trainable decoder 655, and pre-multiplied image 660.

According to an embodiment of the present disclosure, the first image generation model 600 is configured to generate a transparent image while generating a plurality of transparent layers. In some cases, the first image generation model is configured to adjust the latent space of the latent diffusion model to support an encoding or a decoding of the transparent image. In some cases, the first image generation model 600 is configured to adapt pretrained latent diffusion models with the adjusted latent space to generate transparent images.

In some cases, for example in case of a transparent image 605 Iₜ ∈ [symbol] ^{h×w×4}, the first 3 RGB color channels 615 are denoted as I_{c} ∈ [symbol] ^{h×w×3}. In some cases, the alpha channel 610 is denoted as I_{α}∈ [symbol] ^{h×w×1} for the transparent image 605. In some cases, an undefined area in the color channel 615 I_{c} is padded by an iterative Gaussian filter to prevent an unnecessary edge pattern. In some cases, the transparent image 605 is converted to a pre-multiplied image 660 as I=I_{c}*I_{α}, where * denotes pixelwise multiplication. In some examples, the RGB values are in range [−1,1] and alpha values are in range [0,1].

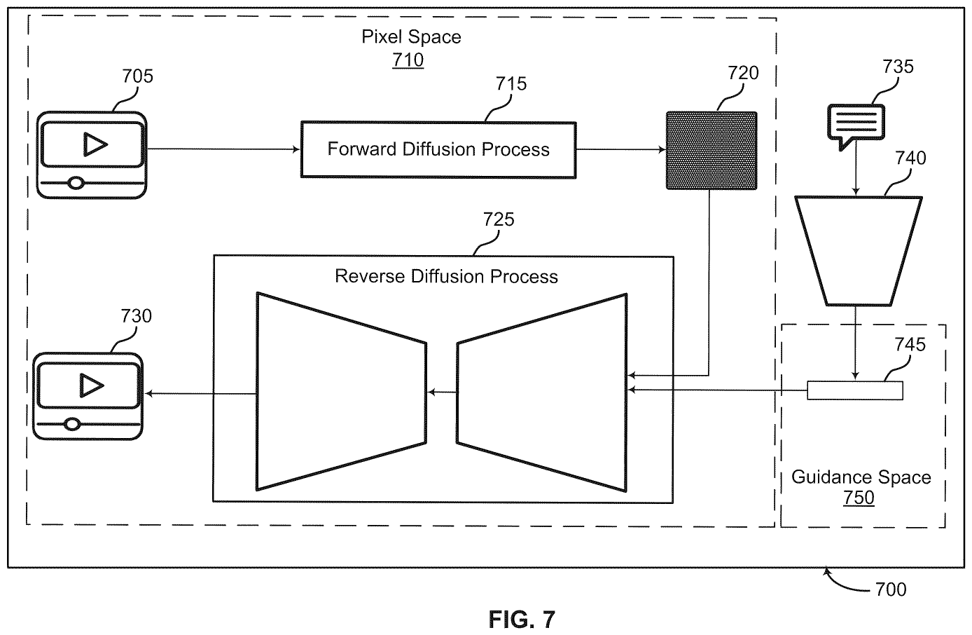

In some examples, the pre-multiplied image 660 I is a non-transparent RGB image that is processed by a RGB-formatted neural network (such as diffusion network 625). In some examples, the diffusion network 625 is configured to generate a decoded image 630 based on the pre-multiplied image 660 I. Diffusion network 625 is an example of, or includes aspects of, the corresponding element described with reference to FIGS. 7-9 and 19.

An embodiment of the present disclosure is configured to incorporate transparency information in the diffusion network. In some cases, the diffusion network 625 uses a latent encoder (such as VAE described with reference to at least FIG. 19) to convert an RGB image to a latent image. In some cases, the latent distribution is identical for the VAE and the diffusion network. In some cases, a mismatch between the VAE and the diffusion network is obtained based on an identity loss [symbol] _{identity}. Further details regarding the loss function are provided with reference to FIG. 14.

For example, given an RGB image I, the corresponding latent image is given as

$$x = {ℰ}_{s d}^{*} ( I ) ,$$

where the diffusion network 625 comprises a pre-trained (i.e., frozen) latent encoder ε_{sd}*(·) and a pre-trained (i.e., frozen) latent decoder

$${𝒟}_{s d}^{*} ( \cdot ) .$$

In some cases, the latent image x is modified by an offset x_{∈} to generate an adjusted latent xₐ=x+x_{∈}.

In some cases, the decoded RGB reconstruction (such as decoded pre-multiplied image 630) is given as

$$\hat{I} = {𝒟}_{s d}^{*} ( {x}_{a} ) .$$

In some cases, the identity loss [symbol] _{identity} associated with the offset x_{∈} is given as:

$${ℒ}_{identity} = ‖ I - \hat{I} {‖}_{2} = {‖ I - {𝒟}_{s d}^{*} ( {ℰ}_{s d}^{*} ( I ) + {x}_{ϵ} ) ‖}_{2} \qquad ( 3 )$$

where ∥·∥₂ is the L2 norm distance (mean squared error). In some cases, a low value of the identity loss [symbol] _{identity} ensures the offset x_{∈} does not break the latent reconstruction and the modified latent is used by the diffusion network 625.

In some cases, the offset is generated using a standard deviation (x_{std}) of the VAE as x_{∈}=λ_{offset}x_{std}x_{offset}, Where x_{offset} is the raw output from a trainable encoder (such as trainable encoder 650), x_{std} is the deviation output of pretrained VAE, and λ_{offset} is a weighting parameter with a default λ_{offset}=1e2.

In some cases, the first image generation model uses the latent offset x_{∈} to generate latent transparency 620 for encoding or decoding of the transparent image (such as transparent image 605). Subsequently, the trainable encoder ε(·,·) 650 is trained to take color channel I_{c} 615 and alpha channel I_{α} 610 as input and convert pixel-space transparency into a latent offset as:

$${x}_{ϵ} = ℰ ( {I}_{c} , {I}_{α} ) \qquad ( 4 )$$

Subsequently, the first image generation model trains a latent transparency decoder [symbol] (·,·) (such as trainable decoder 655) that uses the adjusted latent xₐ=x+x_{∈} and the RGB reconstruction

$$\hat{I} = {𝒟}_{s d}^{*} ( {x}_{a} )$$

(such as decoded pre-multiplied image 630) to extract the transparent image (such as synthetic image 645) from the adjusted latent space:

$$[ {\hat{I}}_{c} {\hat{I}}_{α} ] = 𝒟 ( \hat{I} , {x}_{a} ) \qquad ( 5 )$$

where Î_{c}, Îₐ are the reconstructed color channel (such as decoded color channel 640) and reconstructed alpha channel (such as decoded alpha channel 635), respectively.

In some cases, the reconstruction is evaluated using:

$${ℒ}_{r e c o n} = {‖ {I}_{c} - {\hat{I}}_{c} ‖}_{2} + {‖ {I}_{α} - {\hat{I}}_{α} ‖}_{2} \qquad ( 6 )$$

In some cases, a discriminator loss is implemented as:

$${ℒ}_{d i s c} = {ℒ}_{d i s c} ( [ {\hat{I}}_{c} , {\hat{I}}_{α} ] ) \qquad ( 7 )$$

where [symbol] _{disc}([·,·]) is an objective function. The final objective function is given as:

$${ℒ}_{v a e} = {λ}_{r e c o n} {ℒ}_{r e c o n} + {λ}_{i d e n t i t y} {ℒ}_{i d e n t i t y} + {λ}_{d i s c} {ℒ}_{d i s c} \qquad ( 8 )$$

where λ refers to a weighting parameter with λ_{recon}=1, λ_{identity}=1, λ_{disc}=0.01.

By training the first image generation model with the final objective function ( [symbol] ᵥₐₑ), embodiments of the present disclosure are able to encode the adjusted latent (xₐ) from the transparent image (Iₜ) or encode the transparent image from the adjusted latent, where the latent image is used in fine-tuning the diffusion network (such as diffusion network 625). Additional details regarding a training of the first image generation model are provided with reference to at least FIG. 14.

FIG. 7 shows an example of a guided diffusion model 700 according to aspects of the present disclosure. In some examples, guided diffusion model 700 describes the operation and architecture of the machine learning model 1915 described with reference to FIG. 19. The guided latent diffusion model 700 depicted in FIG. 7 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 700 may take an original media item 705 in a pixel space 710 as input and apply forward diffusion process 715 to gradually add noise to the original media item 705 to obtain noisy media item 720 at various noise levels.

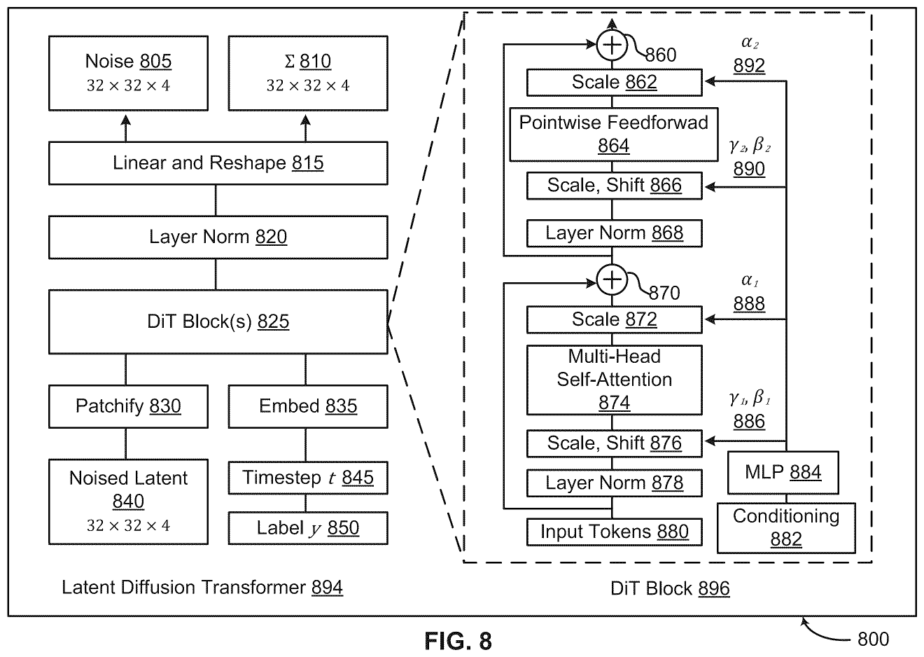

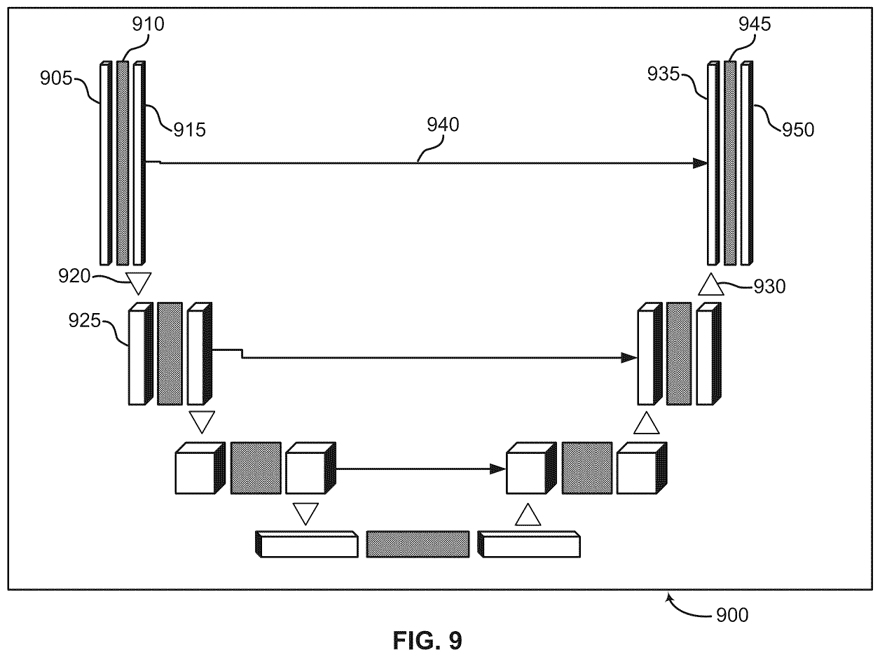

Next, a reverse diffusion process 725 (e.g., a U-Net) gradually removes the noise from the noisy media item 720 at the various noise levels to obtain an output media item 730. In some cases, an output media item 730 is created from each of the various noise levels. The output media item 730 can be compared to the original media item 705 to train the reverse diffusion process 725. In some cases, the reverse diffusion process 725 may include a diffusion transformer architecture as described with reference to FIG. 8 or a U-Net as described with reference to FIG. 9.

The reverse diffusion process 725 can also be guided based on a text prompt 735, or another guidance prompt, such as an image, a layout, a segmentation map, etc. The text prompt 735 can be encoded using a text encoder 765 (e.g., a multimodal encoder) to obtain guidance features 745 in guidance space 750. The guidance features 745 can be combined with the noisy media item 720 at one or more layers of the reverse diffusion process 725 to ensure that the output media item 730 includes content described by the text prompt 735. For example, guidance features 745 can be combined with the noisy features using a cross-attention block within the reverse diffusion process 725.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 2, 8, 9, 15-17, and 19.

FIG. 8 shows an example of a diffusion transformer (DiT) architecture according to aspects of the present disclosure. The example shown includes noised latent 800, patchify operation 805, timestep embedding 810, DiT block(s), layer normalization 820, linear and reshape layers 825, predicted noise 830, input tokens 835, conditioning tokens 840, self-attention 845, cross-attention 850, and feed-forward network 855.

Patchify operation 805 is an example of, or includes aspects of, the corresponding element described with reference to FIG. 4. Input tokens 835 is an example of, or includes aspects of, the corresponding element described with reference to FIGS. 4 and 10.

The DiT architecture processes noised latent 800, which may be a noised version of an input image encoded in a latent space. Patchify operation 805 divides the noised latent into a sequence of patches that are processed as tokens. The tokens are vector representations of each patch of the image in latent space, and are adjusted through attention processes. Each of the tokens also receives timestep embedding 810, which encodes the current denoising timestep, and a positional embedding which encodes each token's spatial position in the image. The tokens and timestep information are processed through N DiT block(s) 815, where N refers to the number of DiT blocks.

Each DiT block 815 includes multiple processing stages. Initially, a pruning operation is performed where a router model determines which tokens to process or skip based on learned, layer and timestep-adaptive compression ratios. The remaining tokens are processed as input tokens 835, which interact with conditioning tokens 840 through multiple attention mechanisms. Self-attention 845 allows input tokens to attend to each other, while cross-attention 850 enables input tokens to attend to the conditioning tokens 840. The outputs are then processed through feed-forward network 855. This process repeats for each DiT block in the sequence.

After processing through all DiT blocks, the outputs undergo layer normalization 820 followed by linear and reshape layers 825. The final output is predicted noise 830, which represents the model's prediction of the noise that was added to create the initial noised latent 800. The predicted noise 830 is removed noised latent 800 at each diffusion timestep. At the end of the denoising schedule, the latent sample is decoded to generate the synthetic image in pixel space.

FIG. 9 shows an example of a U-Net 900 according to aspects of the present disclosure. In some examples, U-Net 900 is an example of the component that performs the reverse diffusion process 725 of guided diffusion model 700 described with reference to FIG. 7 and includes architectural elements of the machine learning model 1915 described with reference to FIG. 19. The U-Net 900 depicted in FIG. 9 is an example of, or includes aspects of, the architecture used within the reverse diffusion process described with reference to FIG. 7.

In some examples, diffusion models are based on a neural network architecture known as a U-Net. The U-Net 900 takes input features 905 having an initial resolution and an initial number of channels and processes the input features 905 using an initial neural network layer 910 (e.g., a convolutional network layer) to produce intermediate features 915. The intermediate features 915 are then down-sampled using a down-sampling layer 920 such that down-sampled features 925 features have a resolution less than the initial resolution and a number of channels greater than the initial number of channels.

This process is repeated multiple times, and then the process is reversed. That is, the down-sampled features 925 are up-sampled using up-sampling process 930 to obtain up-sampled features 935. The up-sampled features 935 can be combined with intermediate features 915 having the same resolution and number of channels via a skip connection 940. These inputs are processed using a final neural network layer 945 to produce output features 950. In some cases, the output features 950 have the same resolution as the initial resolution and the same number of channels as the initial number of channels.

In some cases, U-Net 900 takes additional input features to produce conditionally generated output. For example, the additional input features could include a vector representation of an input prompt. The additional input features can be combined with the intermediate features 915 within the neural network at one or more layers. For example, a cross-attention module can be used to combine the additional input features and the intermediate features 915. U-Net architecture is an example of, or includes aspects of, the corresponding element described with reference to FIGS. 7, 9, 15-17, and 19.

FIG. 10 shows a diffusion process 1000 according to aspects of the present disclosure. In some examples, diffusion process 1000 describes an operation of the machine learning model 1915 described with reference to FIG. 19 or machine learning model 2000 described with reference to FIG. 20, such as the reverse diffusion process 725 of guided diffusion model 700 described with reference to FIG. 7.

As described above with reference to FIG. 7, using a diffusion model can involve both a forward diffusion process 1005 for adding noise to a media item (or features in a latent space) and a reverse diffusion process 1010 for denoising the media item (or features) to obtain a denoised media item. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy media item 1015 and denoises the data to obtain the p (xₜ₋₁|xₜ). At each step t−1, the reverse diffusion process 1010 takes xₜ, such as first intermediate media item 1020, and t as input. Here, t represents a step in the sequence of transitions associated with different noise levels, The reverse diffusion process 1010 outputs xₜ₋₁, such as second intermediate media item 1025 iteratively until x_{T} reverts back to x₀, the original media item 1030. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 9 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 10 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x₇ represent noisy media items, and \tilde{x} represents the generated item with high quality. Diffusion process is an example of, or includes aspects of, the corresponding element described with reference to FIGS. 2, 7-9, 15-17, and 19.

Accordingly, an apparatus for image processing is described. One or more aspects of the apparatus include a memory component; a processing device coupled to the memory component, the processing device configured to perform operations comprising: obtaining a first prompt indicating a foreground object and a second prompt indicating a background scene; generating, using a first image generation model, a foreground attention output based on the first prompt, wherein the foreground attention output represents the foreground object; generating, using a second image generation model, a blended attention output based on the first prompt and the second prompt, wherein the blended attention output represents the foreground object with the background scene; combining the foreground attention output and the blended attention output to obtain a combined blended attention output; and generating, using the second image generation model, a synthetic blended image depicting the foreground object in the background scene based on the combined blended attention output.

In some aspects, the first image generation model comprises a latent diffusion network. In some aspects, the first image generation model generates images with a transparency channel.

In some aspects, the first image generation model comprises a variational autoencoder network, wherein the variational autoencoder is configured to generate a color channel information and the transparency channel. In some aspects, the first image generation model includes an attention layer, and wherein the combined blended attention output is based on an output of the attention layer. Some examples of the apparatus and system further include a connection between a layer of the second image generation model and a corresponding layer of the first image generation model.

### Image Blending Process

Embodiments of the present disclosure are configured to provide an image generation model based on a latent diffusion network. The image generation model of the present disclosure is able to generate layered content while generating a harmonized foreground layer and background layer. In some cases, the image generation model performs a harmonized image generation process that enables dynamic interactions between the layers resulting in a coherent and aesthetically pleasing generated image.

In some cases, the image generation model leverages a cross-attention mask and a self-attention mask extracted from the first image generation model. In some cases, by using the extracted cross-attention mask and the self-attention mask, embodiments of the present disclosure are able to simultaneously guide the generation of the foreground layer and the background layer in a context-aware manner.

The image processing apparatus is based on a latent diffusion model that is configured to generate a harmonized foreground (RGBA) layer and a background (RGB) layer. Thus, the image processing apparatus comprises an image generation model that generates an image with two distinct layers, i.e., a foreground layer and a background layer.

In some cases, the harmonization between the foreground layer and the background layer relies on the quality of the cross-attention mask and the self-attention mask extracted from the first image generation model. Each of the first image generation model and the second image generation model is based on a pre-trained latent diffusion network for generation of the foreground and the background, respectively.

According to an embodiment, the first image generation model is configured to use a structure prior information from the last attention map of the foreground diffusion model, ∈_{θ,FG}. In some cases, the structure prior extracted from the last self-attention layer provides a precise estimate of the shape of the generated foreground element.

In some cases, the image processing apparatus is configured to perform a blending operation comprising three sub-procedures, extraction of the structure prior information, extraction of the content confidence prior information, and the attention blending.

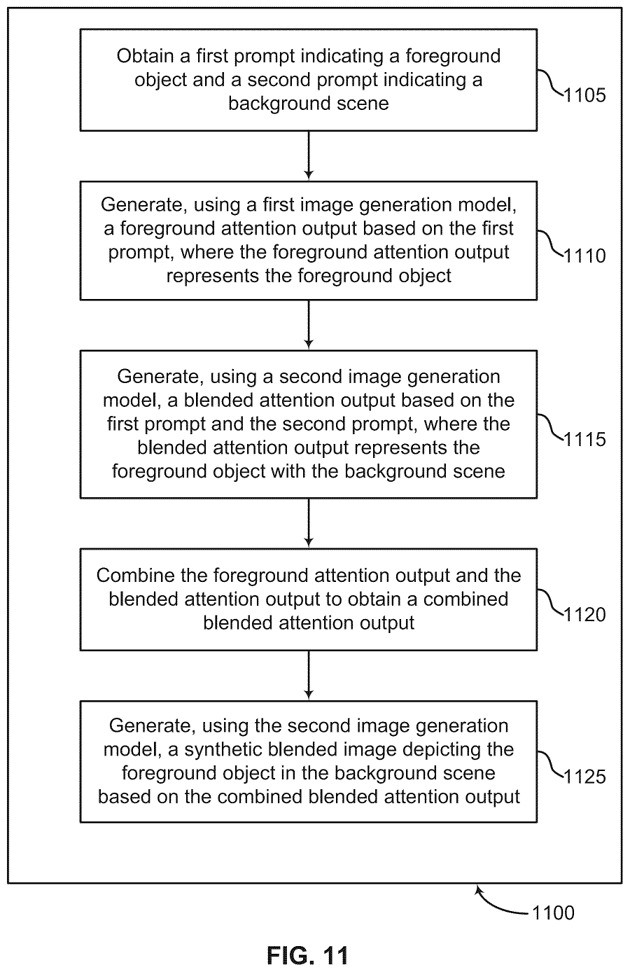

FIG. 11 shows an example of a method 1100 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations. Further details regarding each of operations 1105 to 1125 are provided with reference to at least FIG. 5.

At operation 1105, the system obtains a first prompt indicating a foreground object and a second prompt indicating a background scene. In some cases, the operations of this step refer to, or may be performed by, an image processing apparatus as described with reference to FIG. 19.

For example, in some cases, the user interface of the image processing apparatus (such as image processing apparatus 1900 described with reference to FIG. 19) receives an input prompt from a user. In some examples, the input prompt comprises a first text prompt that describes a foreground object that the user wants to depict in the generated asset (e.g., synthetic image). Additionally or alternatively, for example, the input prompt comprises a second text prompt that describes a background scene that the user wants to depict in the generated asset (e.g., synthetic image). In some examples, the image processing apparatus receives the input prompt from a database or any other data source.

The image processing apparatus of the present disclosure includes a first image generation model (such as the first image generation model described with reference to FIGS. 5-9 and 20) and a second image generation model (such as the second image generation model described with reference to FIGS. 5, 7-9 and 20) configured to perform an image generation process. In some examples, the image processing apparatus is used to perform two passes on the denoising network (such as the denoising network described with reference to FIGS. 7-10) during each inference step.

For example, in case of the first denoising pass to the first image generation model, a structure prior information (such as structure prior information 540 described with reference to FIG. 5) is extracted from the last self-attention layer of the diffusion network. In some examples, the diffusion network refers to the denoising network that generates the foreground. In some examples, the last self-attention layer of the diffusion network provides a coarse estimate on the shape of the foreground to be generated. For example, a second denoising pass to the first image generation model performs denoising on a background latent, a foreground latent, and a blended latent using the structure prior information. In some examples, the cross-attention maps for blending are utilized during the second pass.

During the second denoising pass, the first image generation model uses the denoising network for generating the foreground object (such as foreground object 515) and the second image generation model is trained for RGB generation. By formulating the triplet generation (i.e., foreground image, background image, and blended image) as an operation among foreground latent, background latent, and blended latent, embodiments of the present disclosure enable information transfer among the said latent vectors and the corresponding text prompts.

At operation 1110, the system generates, using a first image generation model, a foreground attention output based on the first prompt, where the foreground attention output represents the foreground object. In some cases, the operations of this step refer to, or may be performed by, a first image generation model as described with reference to FIG. 20. As used herein, the foreground attention output refers to the result of an attention mechanism based on the first prompt. In some cases, the foreground attention output is computed based on the query, key, and value vectors associated with the first prompt.

According to an embodiment of the present disclosure, the first image generation model is configured to extract the structure prior information as a soft foreground map. In some cases, the hidden features output from the self-attention layer of the last transformer block of the denoising network are used for the extraction. For example, the last transformer block is closest to the latent-level information and hence provides the foreground shape accurately. The first image generation model is configured to generate an attention probability map m∈ [symbol] _{M×M} from query value and key value of the attention block (such as foreground attention output 510 described with reference to FIG. 5) using the hidden states of the subjected self-attention layer.

The second dimension of the probability map corresponds to the cross-correlation values between one pixel and every other pixel as a probability distribution. In some examples, the foreground denoising network is exclusively responsible for generating the foreground object. In some cases, a dense distribution for the cross-correlation values corresponds to a foreground pixel which implies that each of the pixels vote uniformly to the subjected pixel.

Additionally, the first image generation model computes a per-pixel sparsity score to classify a pixel as a part of the foreground or background. In some cases, the per-pixel sparsity score is computed using the corresponding probability distribution as:

$${s}_{i} = \frac{1}{{\sum }_{j = 1}^{M} {m}_{i , j}^{2}} \qquad ( 11 )$$

The mask corresponding to foreground pixels is used as

$${s}_{i}^{′} = 1 - normalize ( {s}_{i} )$$

since the subjected metric utilizes assigns a sparsity score to each variable sᵢ.

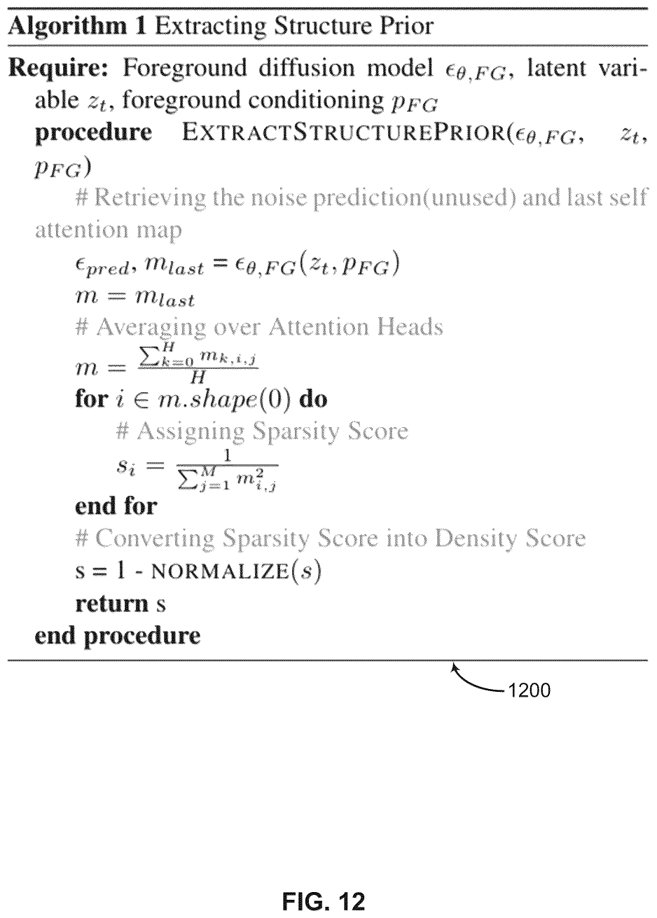

In some cases, a dense probability distribution is preferred compared to a sparse probability distribution. In some cases, a normalization is applied that scales the sparsity values sᵢ between 0-1 since a foreground confidence value between 0-1 is assigned for effective blending. The normalization operation is given as:

$$normalize ( {x}_{i} ) = \frac{{x}_{i} - min ( x )}{max ( x ) - min ( x )} \qquad ( 12 )$$

where min and max values are calculated over the feature map obtained. Further details regarding extraction of the structure prior information are provided with reference to FIG. 12.

At operation 1115, the system generates, using a second image generation model (i.e., a different image generation model from the first image generation model), a blended attention output based on the first prompt and the second prompt, where the blended attention output represents the foreground object with the background scene. In some cases, the operations of this step refer to, or may be performed by, a second image generation model as described with reference to FIG. 20. As used herein, the blended attention output refers to the result of an attention mechanism based on the first prompt and the second prompt. In some cases, the blended attention output corresponds to the attention block output for the blended image.

In some cases, the second image generation model obtains content confidence maps for attention level blending using cross-attention maps. In some cases, the second image generation model is configured to utilize probability map corresponding to the EOS token of the conditional features. In some examples, the second image generation model is used to extract two maps using the probability map across attention heads.

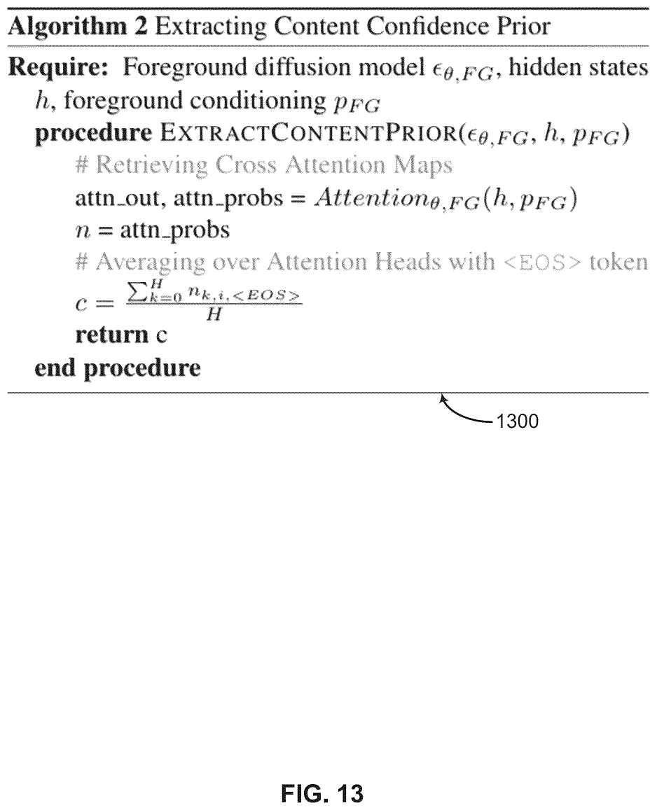

For example, a first cross-attention map is used for blending, c_{blend} and a second cross-attention map is used for reflecting the blended changes back to the foreground, c_{FG}. In some cases, the second image generation model computes a mean of the probability values across attention heads since blending a background layer and foreground layer uses soft attention probabilities. In some cases, a max(·) function for the mask is used to reflect the changes back to the foreground hidden states. The blending maps b_{blend} and b_{FG} are used to combine the extracted structure prior map and the content confidence map based on the extracted attention maps.

$${b}_{blend , i} = {s}_{i} * {c}_{blend , i} \qquad ( 13 )$$

$${b}_{fg , i} = {s}_{i} * {c}_{fg , i} \qquad ( 14 )$$

where i denotes the index for the subjected hidden state index for the features to be blended. Further details regarding extraction of the content confidence prior information are provided with reference to FIG. 13.

At operation 1120, the system combines the foreground attention output and the blended attention output to obtain a combined blended attention output. In some cases, the operations of this step refer to, or may be performed by, a second image generation model as described with reference to FIG. 20.

As used herein, the combined blended attention output refers to a result of blending features obtained from the cross-attention layer and the self-attention layer of a transformer block in the denoising network of each of the first image generation model and the second image generation model. For instance, the combined blended attention output is generated based on a combination of the blended attention output, the foreground attention output, and a blending map, wherein the blending map is obtained based on the structure prior information and the content confidence prior information.

According to an embodiment of the present disclosure, the second image generation model is configured to obtain the cross-attention output and the self-attention output of the transformer block in the denoising network as the features to be blended. In some cases, the cross-attention output and the self-attention output are obtained based on the content confidence maps extracted for blending.

The blending (such as the blending operation 560 described with reference to FIG. 5) is performed based on the foreground attention output a_{FG}, the blended attention output a_{blend}, and the background attention output @BG, wherein the attention outputs correspond to the foreground image, the blended image, and the background image, respectively.

$${a}_{blend}^{′} = {a}_{F G} * {b}_{blend} + {a}_{blend} * ( 1 - {b}_{blend} ) \qquad ( 15 )$$

$${a}_{FG}^{′} = {a}_{blend}^{′} * {b}_{F G} + {a}_{F G} * ( 1 - {b}_{F G} ) \qquad ( 16 )$$

Additionally, the second image generation model performs an attention sharing based background attention computation. By computing the attention sharing based background attention, embodiments of the present disclosure ensure consistency across the blended hidden state h_{blend} and the background hidden state h_{BG}. In some cases, the computation is performed prior to the blending operation and generates an initial attention output corresponding to the blended image and background image, a_{blend} and a_{BG}, respectively. The shared attention is computed as:

$${a}_{B G} , {a}_{blend} = Attn ( concat ( {h}_{B G} , {h}_{blend} ) ) \qquad ( 17 )$$

In some cases, the second image generation model uses the attention values as

$${a}_{FG}^{′} , {a}_{blend}^{′} ,$$

and a_{BG}. Further details regarding the attention based blending are provided with reference to FIG. 14.

At operation 1125, the system generates, using the second image generation model, a synthetic blended image depicting the foreground object in the background scene based on the combined blended attention output. In some cases, the operations of this step refer to, or may be performed by, a second image generation model as described with reference to FIG. 20.

In some cases, the synthetic image is generated via a diffusion process based on the combined blended attention output as described with reference to at least FIGS. 7-10. In some cases, the second image generation model provides the synthetic image to the user via the user interface (such as the user interface described with reference to at least FIGS. 1-5) of the user device.

Embodiments of the present disclosure are configured to perform blending in a structure aware manner. In some cases, the first image generation model is used to extract a mask from the self-attention layer and a mask from the cross-attention layer to perform the blending operation. For example, in case of a foreground image latent being denoised during the diffusion process, each timestep encodes an implicit representation of the foreground shape for the structure-aware blending of attention outputs. Additionally, the attention output of the self-attention layer and the cross-attention layer enables information sharing across the foreground image, the background image, and the blended image for performing the blending operation. In some cases, the first image generation model and the second image generation model enable an attention-level alpha blending and blending of the contextual information from the text prompt for performing a blending of the background image and the foreground image.

FIG. 12 shows an example of an algorithm 1200 for extracting structure prior information according to aspects of the present disclosure.

Algorithm 1200 includes a function for extracting structure prior information. The function takes a foreground diffusion model ∈_{θ,FG}, latent variable zₜ, and foreground conditioning p_{FG} as input and generates a sparsity score s as output. In some cases, algorithm 1200 starts with retrieving the unused noise prediction and the last self-attention map. In algorithm 1200, ∈_{pred},mₗₐₛₜ=∈_{θ,FG}(zₜ,p_{FG}) and m=mₗₐₛₜ.

Subsequently, algorithm 1200 averages over attention heads

$$m = \frac{{\sum }_{k = 0}^{H} {m}_{k , i , j}}{H} .$$

Next, for i∈m.shape(0), algorithm 1200 assigns sparsity score as:

$${s}_{i} = \frac{1}{{\sum }_{j = 1}^{M} {m}_{i , j}^{2}} .$$

Finally, algorithm 1200 converts the sparsity score into a density score as: s=1−NORMALIZE(s). Finally, algorithm 1200 returns density score s as the output.

FIG. 13 shows an example of an algorithm 1300 for extracting content confidence prior information according to aspects of the present disclosure.

Algorithm 1300 includes a function for extracting content confidence prior information. The function takes a foreground diffusion model ∈_{θ,FG}, hidden states h, and foreground conditioning p_{FG} as input. Algorithm 1300 starts with retrieving cross-attention maps as: attnₒᵤₜ,attn_{probs}=Attention_{θ,FG}(h,p_{FG}) and n=attn_{probs}.

Next, algorithm 1300 averages over attention heads with <EOS token as:

$$c = \frac{{\sum }_{k = 0}^{H} {n}_{k , i , 〈 EOS 〉}}{H} .$$

The algorithm 1300 returns c as the output.

FIG. 14 shows an example of an algorithm 1400 for attention blending according to aspects of the present disclosure.

Algorithm 1400 includes a function for attention blending. The function takes a foreground diffusion model ∈_{θ,FG}, RGB diffusion model Ee, foreground hidden states h_{FG}, blended hidden states h_{Blended}, background hidden states h_{BG}, foreground conditioning p_{FG}, background conditioning p_{BG}, boundary coefficient d, and structure prior s as input.

Algorithm 1400 starts with performing layer normalization for the cross-attention layer as: h_{norm,FG}, h_{norm,Blended}, h_{norm,BG}=LAYER−NORMCROSSATTN(h_{FG},h_{Blended},h_{BG}) and c=EXTRACTCONTENTPRIOR ∈_{θ,FG},h_{norm,FG},p_{FG}.

Subsequently, algorithm 1400 retrieves the blending soft mask as: mask_{soft}=NORMALIZE(s*c).

Next, algorithm 1400 retrieves the blending hard mask as: mask_{hard}=σ(d*(mask_{soft}−0.5)

Algorithm 1400 computes the attention as: a_{BG},a_{Blended}=Attention_{θ}([h_{BG},h_{Blended}],p_{BG}) and a_{FG}=Attention_{θ,FG}(h_{FG},p_{BG}). Subsequently, algorithm 1400 performs the blending step to generate the combined blended attention output and the combined foreground attention output as:

$${a}_{Blended}^{′} = {a}_{F G} * {mask}_{soft} + {a}_{Blended} * ( 1 - {mask}_{soft} ) and$$

$${a}_{FG}^{′} = {a}_{Blended}^{′} * {mask}_{hard} + {a}_{F G} * ( 1 - {mask}_{hard} ) ,$$

respectively.
Algorithm 1400 returns the combined foreground attention output a′_{FG}, the combined blended attention output a′_{Blended}, and background attention output a_{BG} as output.

Accordingly, a method for image processing is described. One or more aspects of the method include obtaining a first prompt indicating a foreground object and a second prompt indicating a background scene; generating, using a first image generation model, a foreground attention output based on the first prompt, wherein the foreground attention output represents the foreground object; generating, using a second image generation model, a blended attention output based on the first prompt and the second prompt, wherein the blended attention output represents the foreground object with the background scene; combining the foreground attention output and the blended attention output to obtain a combined blended attention output; and generating, using the second image generation model, a synthetic blended image depicting the foreground object in the background scene based on the combined blended attention output.

Some examples of the method, apparatus, and non-transitory computer readable medium further include combining the foreground attention output and the blended attention output comprises: extracting structure prior information from the first image generation model. Some examples further include extracting blended content confidence information from the second image generation model. Some examples further include computing a blended mask based on the structure prior information and the blended content confidence information, wherein the foreground attention output and the blended attention output are combined based on the blended mask.

Some examples of the method, apparatus, and non-transitory computer readable medium further include extracting foreground content confidence information from the first image generation model. Some examples further include computing a foreground mask based on the structure prior information and the foreground content confidence information. Some examples further include combining the foreground attention output and the combined blended attention output based on the foreground mask to obtain a combined foreground attention output.

Some examples of the method, apparatus, and non-transitory computer readable medium further include generating the blended attention output comprises: generating background features representing the background scene. Some examples further include generating blended features representing the foreground object in the background scene. Some examples further include performing attention sharing on the background features and the blended features to obtain the blended attention output.

Some examples of the method, apparatus, and non-transitory computer readable medium further include generating, using the first image generation model, a synthetic foreground image depicting the foreground object. Some examples further include generating, using the second image generation model, a synthetic background image depicting the background scene.

In some aspects, the first image generation model generates images with a transparency channel.

Some examples of the method, apparatus, and non-transitory computer readable medium further include obtaining the first prompt and the second prompt comprises: obtaining an input prompt describing the foreground object and the background scene. Some examples further include extracting the first prompt and the second prompt from the input prompt.

### Training

The present disclosure describes systems and methods for generating an image triplet comprising a foreground image, a background image, and a blended image, wherein the images are combined in a realistic manner. In some cases, a first image generation model is used for generation of a foreground image. In some cases, a second image generation model is used for generation of a background image and a blended image. In some cases, the second image generation model is configured to combine the information of the image triplet and generate a blended image that represents the image details from the foreground image and the background image. The second image generation model generates an image triplet using a prompt for the foreground and a prompt for the background with a single iterative denoising process.

Embodiments of the present disclosure are configured to perform an image blending process that utilizes the self-attention output and a cross-attention output in a denoising diffusion model. By utilizing the image blending process that includes internal representations of the image, embodiments of the present disclosure provide for information exchange along the generative priors of the foreground image, the background image, and the blended image during generation time.

In some cases, the image processing apparatus is configured to use the self-attention probability map and the cross attention probability map to explicitly extract object structure information. For example, the self-attention probability map and the cross attention probability map is used to extract the blending maps during generation time. In some examples, the image processing apparatus includes the first image generation model and the second image generation model, wherein each of the first image generation model and the second image generation model interactively perform generation of the harmonized layered image using a training-free operation.

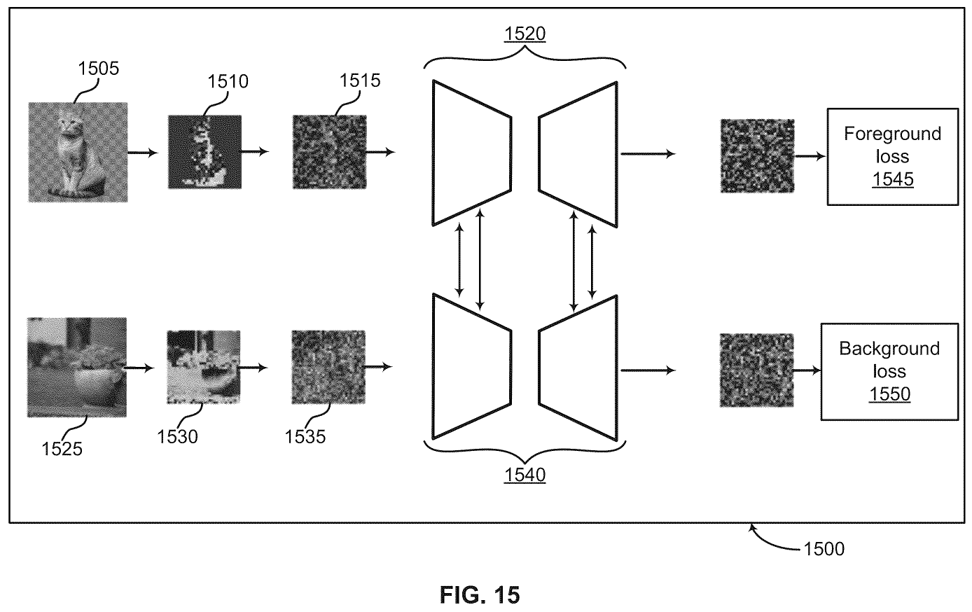

FIG. 15 shows an example of a method of training the first image generation model 1500. In one aspect, the first image generation model training process 1500 includes transparent foreground image 1505, foreground mask 1510, foreground latent noise 1515, foreground diffusion network 1520, background scene 1525, background mask 1530, background latent noise 1535, background diffusion network 1540, foreground loss 1545, and background loss 1550.

In some cases, a training of a multi-layer first image generation model (such as first image generation model 505 described with reference to FIG. 5 and first image generation model 600 described with reference to FIG. 6) is performed based on an attention sharing mechanism. As shown in FIG. 15, foreground diffusion network 1520 and background diffusion network 1540 are trained based on a foreground latent noise 1515 and a background latent noise 1535, respectively. In some cases, the foreground diffusion network 1520 is parameterized by θ_{f} to denoise the foreground latent image. In some cases, the background diffusion network 1540 is parameterized by θ_{b} to denoise the background latent image.

Based on the foreground diffusion network 1520 and the background diffusion network 1540 independently denoising the foreground latent noise 1515 and the background latent noise 1535, respectively, the corresponding objectives are generated as:

$$\{ \begin{matrix}{𝔼}_{{x}_{f} , t , {c}_{t} , {ϵ}_{f} ∼ 𝒩 ( 0 , 1 )} [ {‖ {ϵ}_{f} - {ϵ}_{θ , {θ}_{f}} ( {x}_{f} , t , {c}_{t} ) ‖}_{2}^{2} ] \\ {𝔼}_{{x}_{b} , t , {c}_{t} , {ϵ}_{b} ∼ 𝒩 ( 0 , 1 )} [ {‖ {ϵ}_{b} - {ϵ}_{θ , {θ}_{b}} ( {x}_{b} , t , {c}_{t} ) ‖}_{2}^{2} ]\end{matrix} \qquad ( 18 )$$

where ∈_{f} and ∈_{b} are foreground latent noise 1515 and background latent noise 1535, respectively.

Subsequently, the foreground diffusion network 1520 and the background diffusion network 1540 are merged to obtain a coherent generation. In some cases, for each attention layer in the diffusion network, a key vector, a query vector, and a value vector activated by the foreground image 1505 and background image 1525 are concatenated. By concatenating the key vector, the query vector, and the value vector activated by the foreground image and the background image, the two passes are merged into a jointly optimized model ∈_{θ,θ}_{_{f}}_{,θ}_{_{g}}(·).

In some cases, the merged noise is depicted as concatenated ∈ₘ=[∈_{f}, ∈_{b}]. The foreground loss 1545 and the background loss 1550 are obtained as:

$${ℒ}_{l a y e r} = {𝔼}_{{x}_{f} , {x}_{b} , t , {c}_{t} , {ϵ}_{m} ∼ 𝒩 ( 0 , 1 )} [ {‖ {ϵ}_{m} - {ϵ}_{θ , {θ}_{f} , {θ}_{g}} ( {x}_{f} , {x}_{b} , t , {c}_{t} ) ‖}_{2}^{2} ] \qquad ( 19 )$$

In some cases, [symbol] _{layer} is used to coherently generate multiple layers together. In some examples, [symbol] _{layer} is modified for conditional layer generation (e.g., foreground-conditioned background generation and background-conditioned foreground generation). By using a clean latent image for the foreground (i.e., instead of latent noise by setting ∈_{f}=0), the first image generation model prevents a denoising of the foreground and is used as a foreground-conditioned generator. Additionally or alternatively, by using a clean latent image for the background (i.e., instead of latent noise by setting ∈_{b}=0), the first image generation model prevents a denoising of the background and is used as a background-conditioned generator.

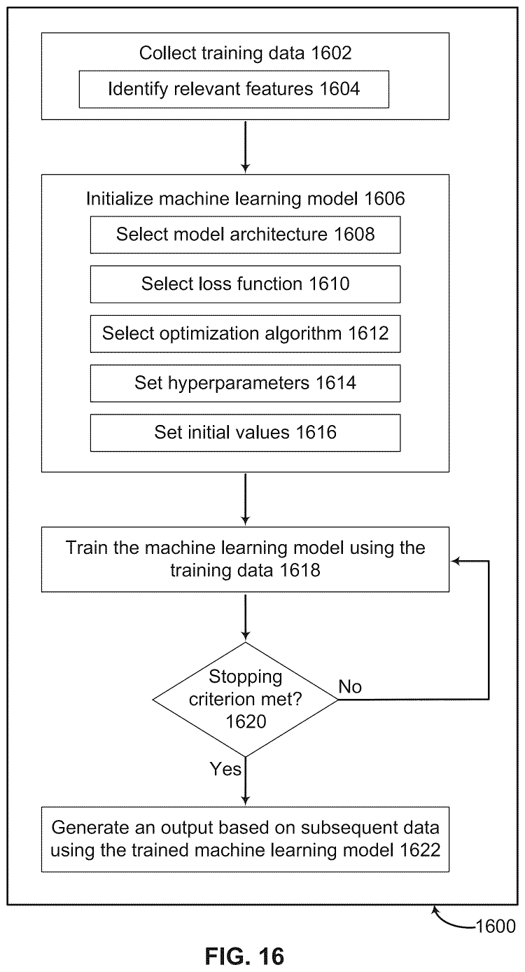

FIG. 16 shows an example of a method of training a machine learning model according to aspects of the present disclosure. FIG. 16 is a flow diagram depicting an algorithm as a step-by-step procedure 1600 in an example implementation of operations performable for training a machine-learning model. In some embodiments, the procedure 1600 describes an operation of the training component 1925 described for configuring the machine learning model 1915 as described with reference to FIG. 19. The procedure 1600 provides one or more examples of generating training data, use of the training data to train a machine-learning model, and use of the trained machine-learning model to perform a task.

To begin in this example, a machine-learning system collects training data (block 1602) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1604) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1606). Initialization of the machine-learning model includes selecting a model architecture (block 1608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1610). The loss function is utilized to measure a difference between an output of the machine-learning model (i.e., predictions) and target values (e.g., as expressed by the training data) to be used to train the machine-learning model. Additionally, an optimization algorithm is selected (1612) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1614) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1618) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1620), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1620), the procedure 1600 continues training of the machine-learning model using the training data (block 1618) in this example.

If the stopping criterion is met (“yes” from decision block 1620), the trained machine-learning model is then utilized to generate an output based on subsequent data (block 1622). The trained machine-learning model, for instance, is trained to perform a task as described above and therefore once trained is configured to perform that task based on subsequent data received as an input and processed by the machine-learning model. The machine learning model, is an example of, or includes aspects of, the image generation model described with reference to FIGS. 2, 7-9, 16-18.

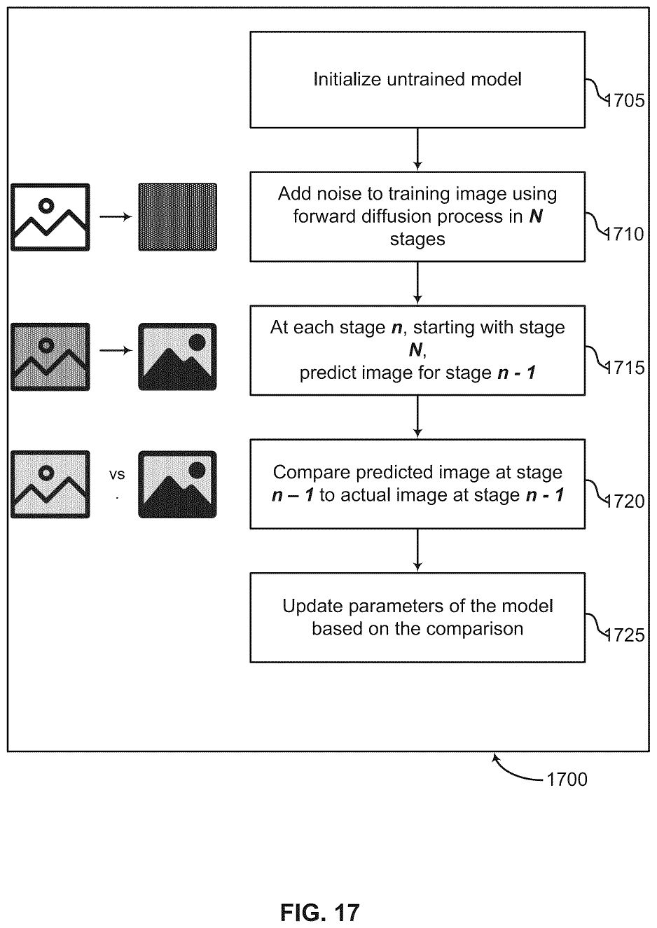

FIG. 17 shows an example of a method of training a diffusion model 1700 according to aspects of the present disclosure. In some embodiments, the method 1700 describes an operation of the training component 1925 described for configuring the machine learning model 1915 as described with reference to FIG. 19. The method 1700 represents an example for training a reverse diffusion process as described above with reference to FIGS. 7-9. In some examples, these operations are performed by a system including a processor executing a set of codes to control functional elements of an apparatus, such as the guided diffusion model described in FIG. 7.

Additionally or alternatively, certain processes of method 1700 may be performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 17, according to some aspects, a training component (such as the training component 1925 described with reference to FIG. 19) trains a diffusion model (such as the machine learning model described with reference to FIGS. 5-9 and 19-20) to generate an output.

At operation 1705, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1710, the system adds noise to a training image (or an additional training image) using a forward diffusion process (such as the forward diffusion process described with reference to FIG. 7) in N stages. In some cases, the operations of this step refer to, or may be performed by, a training component as described with reference to FIG. 19.

At operation 1715, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1720, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1725, the system updates parameters of the model based on the comparison. For example, parameters of a U-Net may be updated using gradient descent. Time-dependent parameters of the Gaussian transitions can also be learned.

Accordingly, a method for image processing is described. One or more aspects of the method include obtaining a first prompt indicating a foreground object and a second prompt indicating a background scene; generating foreground features representing the foreground object, background features representing the background scene, and blended features representing the foreground object in the background scene; generating, using an image generation model, a combined blended attention output based on the foreground features, the background features, and the blended features; and generating, using the image generation model, a synthetic blended image depicting the foreground object in the background scene based on the combined blended attention output.

Some examples of the method, apparatus, and non-transitory computer readable medium further include generating the combined blended attention output comprises: extracting structure prior information based on the foreground features. Some examples further include extracting blended content confidence information from the image generation model. Some examples further include computing a blended mask based on the structure prior information and the blended content confidence information, wherein the foreground features and the blended features are combined based on the blended mask.

Some examples of the method, apparatus, and non-transitory computer readable medium further include extracting foreground content confidence information. Some examples further include computing a foreground mask based on the structure prior information and the foreground content confidence information. Some examples further include combining the foreground features and the combined blended attention output based on the foreground mask to obtain a combined foreground attention output.

Some examples of the method, apparatus, and non-transitory computer readable medium further include generating the blended attention output comprises: generating background features representing the background scene. Some examples further include generating blended features representing the foreground object in the background scene. Some examples further include performing attention sharing on the background features and the blended features to obtain the blended attention output.

Some examples of the method, apparatus, and non-transitory computer readable medium further include generating a synthetic foreground image depicting the foreground object. Some examples further include generating, using the image generation model, a synthetic background image depicting the background scene. In some aspects, a first image generation model generates images with a transparency channel.

Some examples of the method, apparatus, and non-transitory computer readable medium further include obtaining the first prompt and the second prompt comprises: obtaining an input prompt describing the foreground object and the background scene. Some examples further include extracting the first prompt and the second prompt from the input prompt.

### EXPERIMENTS AND IMPLEMENTATIONS

An exemplary embodiment is configured to perform a qualitative and quantitative evaluation of the image processing apparatus of the present disclosure. In some examples, an effectiveness of the image processing apparatus is evaluated to generate a high-quality and harmonized layered image. For example, the image processing apparatus outperforms existing image generation methods in parameters including, but not limited to, visual coherence, image quality, and layer consistency.

In some examples, the first image generation model and the second image generation model are each based on a diffusion model such as a SDXL model. In some examples, the image processing apparatus uses a single NVIDIA L40 GPU. According to an example, the image processing apparatus achieves harmonious blending and depicts smooth foreground and background images. According to an example, the harmonious blending of the foreground and the background is achieved based on simultaneous generation of the foreground image and the background image. For example, simultaneous generation results in precise foreground for the cases that include interaction between foreground and background layers (e.g. “legs of the horse occluded in the grass”).

An exemplary embodiment of the present disclosure evaluates an effect of a change in the background prompt on the foreground content. In some examples, the image processing apparatus is configured to perform an adjustment to a foreground (e.g., clothing or accessories of a person, as well as fine-grained details such as adding snow on the boots) based on varying the background conditions (e.g., changing weather scenario).

According to an exemplary embodiment, the image processing apparatus is configured to perform a generative blending operation by exchanging intermediate outputs of the image generation models. For example, by performing the generative blending operation, embodiments of the present disclosure are able to generate visually appealing images by handling subtle elements such as shadows and lighting, which ensures the generated image appears natural and harmonized with the background.

According to an exemplary embodiment, an attention mask is used to control an interaction between the foreground layer and the background layer. In some cases, by using a self-attention map with a cross-attention map, embodiments of the present disclosure are able to provide precise boundary information and prevent an undesired information loss from a pre-multiplied image (i.e., the output from the first image generation model with a gray background). Additionally, by combining the self-attention map with the cross-attention map, embodiments are able to ensure coherence with the bounded region.

In some examples, the soft decision boundary coefficient is used to derive the hard mask during the blending operation. For example, a high value of the soft decision boundary coefficient indicates a defined boundary and provides for accuracy in capturing foreground details. Additionally, the high value of the soft decision boundary coefficient provides for enhanced consistency between the foreground image and the blended image.

An exemplary embodiment of the present disclosure is used to evaluate an alignment of the generated image with the input prompt. In some cases, a similarity of the generated image with the real imaging distribution is obtained based on a KID score and an FID score. For example, an image distribution is evaluated using a KID score with the final pooling layer features of a convolution network (e.g., Inception-V3) to evaluate the similarity overall image distribution. Additionally, an image distribution is evaluated using an FID score with the features from the first pooling layer to evaluate texture level details.

According to an exemplary embodiment of the present disclosure, the image processing apparatus provides a background image distribution that depicts improved alignment with the second image generation model (e.g., diffusion model, ∈_{θ} such as SDXL) while preserving the output distribution of the first image generation model (∈_{θ,FG}).

An embodiment of the present disclosure is configured to perform a sampling of a desired amount of image triplets comprising a foreground image, a background image, and a blended image using a denoising diffusion process. In some cases, the sampling is performed based on the blending operation while preventing use of a trainable module. Additionally, the image processing apparatus enables a user to specify a location of the foreground object with a bounding box that bounds the attended region during the denoising process. In some cases, the image processing apparatus provides the user with a corresponding alpha channel which enables flexibility of freely moving the foreground asset since the first image generation model is used for generation of the foreground region.

An exemplary embodiment of the present disclosure is configured to perform a user study of 50 participants with 40 image triplets. For example, the image triplets are generated by the first image generation model and the second image generation model. In some examples, the triplets comprise images with an animal, vehicle, matte objects, person, and objects with transparency properties as the foreground to obtain a sample representing a distribution of subjects.

In some examples, the users rate each image triplet from a scale of 1-to-5 considering the realistic attribute and natural blend of each image. The users are supplied the foreground prompt and the background prompt used to generate the image triplet.

### Computing Device

Embodiments of the present disclosure include a first image generation model and a second image generation model that utilize prior knowledge of the second image generation model about lighting conditions and physical interactions (e.g. grounding) and the foreground and transparency information of the first image generation model. Additionally, embodiments enable an interaction between different prompts (e.g., a foreground prompt and a background prompt) and enable a two-way interaction between the foreground image and the blended image based on the blending attention operation.

By implementing the attention sharing based background generation, embodiments of the present disclosure are able to generate a background image that is harmonized with the blended image and prevents occurrence of a trace of the generated foreground image. Additionally, embodiments enable a user to manipulate a foreground on the background canvas to generate a variety of blended images via alpha blending based on separation of the foreground layer and the background layer.

FIG. 18 shows an example of a computing device according to aspects of the present disclosure. The computing device 1800 may be an example of the image processing apparatus 1900 described with reference to FIG. 19. In one aspect, computing device 1800 includes processor(s) 1805, memory subsystem 1810, communication interface 1815, I/O interface 1820, user interface component(s) 1825, and channel 1830.

In some embodiments, computing device 1800 is an example of, or includes aspects of, the machine learning model of FIGS. 10-20. In some embodiments, computing device 1800 includes one or more processors 1805 that can execute instructions stored in memory subsystem 1810 to perform image generation.

According to some aspects, computing device 1800 includes one or more processors 1805. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1815 operates at a boundary between communicating entities (such as computing device 1800, one or more user devices, a cloud, and one or more databases) and channel 1830 and can record and process communications. In some cases, communication interface 1815 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1820 is controlled by an I/O controller to manage input and output signals for computing device 1800. In some cases, I/O interface 1820 manages peripherals not integrated into computing device 1800. In some cases, I/O interface 1820 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1820 or via hardware components controlled by the I/O controller.

According to some aspects, user interface component(s) 1825 enable a user to interact with computing device 1800. In some cases, user interface component(s) 1825 include an audio device, such as an external speaker system, an external display device such as a display screen, an input device (e.g., a remote-control device interfaced with a user interface directly or through the I/O controller), or a combination thereof. In some cases, user interface component(s) 1825 include a GUI.

FIG. 19 shows an example of an image processing apparatus 1900 according to aspects of the present disclosure. Image processing apparatus 1900 is an example of, or includes aspects of, the corresponding element described with reference to FIGS. 1 and 3-4.

According to some aspects, image processing apparatus 1900 obtains a first prompt indicating a foreground object and a second prompt indicating a background scene. In some examples, image processing apparatus 1900 obtains the first prompt and the second prompt includes obtaining an input prompt describing the foreground object and the background scene. In some examples, image processing apparatus 1900 extracts the first prompt and the second prompt from the input prompt.

According to some aspects, image processing apparatus 1900 obtains a first prompt indicating a foreground object and a second prompt indicating a background scene. In some examples, image processing apparatus 1900 generates foreground features representing the foreground object, background features representing the background scene, and blended features representing the foreground object in the background scene. In some examples, image processing apparatus 1900 extracts the first prompt and the second prompt from an input prompt.

According to some aspects, image processing apparatus 1900 comprises obtaining a first prompt indicating a foreground object and a second prompt indicating a background scene. In some examples, image processing apparatus 1900 comprises a connection between a layer of the second image generation model and a corresponding layer of the first image generation model.

In one aspect, image processing apparatus 1900 includes processor unit 1905, memory unit 1910, I/O module 1920, and training component 1925. Training component 1925 updates parameters of the machine learning model 1915 stored in memory unit 1910. In some examples, the training component 1925 is located outside the image processing apparatus 1900.

According to some aspects, processor unit 1905 comprises a processing device coupled to the memory component. Processor unit 1905 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1905 is configured to operate a memory array using a memory controller. In other cases, a memory controller is integrated into processor unit 1905. In some cases, processor unit 1905 is configured to execute computer-readable instructions stored in memory unit 1910 to perform various functions. In some aspects, processor unit 1905 includes special purpose components for modem processing, baseband processing, digital signal processing, or transmission processing. According to some aspects, processor unit 1905 comprises one or more processors described with reference to FIG. 18.

Memory unit 1910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1905 to perform various functions described herein.

In some cases, memory unit 1910 includes a basic input/output system (BIOS) that controls basic hardware or software operations, such as an interaction with peripheral components or devices. In some cases, memory unit 1910 includes a memory controller that operates memory cells of memory unit 1910. For example, the memory controller may include a row decoder, column decoder, or both. In some cases, memory cells within memory unit 1910 store information in the form of a logical state. According to some aspects, memory unit 1910 is an example of the memory subsystem 1810 described with reference to FIG. 18.

According to some aspects, image processing apparatus 1900 uses one or more processors of processor unit 1905 to execute instructions stored in memory unit 1910 to perform functions described herein. For example, the image processing apparatus 1900 may obtain a first prompt indicating a foreground object and a second prompt indicating a background scene; generate, using a first image generation model, a foreground attention output based on the first prompt, wherein the foreground attention output represents the foreground object; generate, using a second image generation model, a blended attention output based on the first prompt and the second prompt, wherein the blended attention output represents the foreground object with the background scene; combine the foreground attention output and the blended attention output to obtain a combined blended attention output; and generate, using the second image generation model, a synthetic blended image depicting the foreground object in the background scene based on the combined blended attention output.

In one aspect, memory unit 1910 includes machine learning model 1915 trained to obtain a first prompt indicating a foreground object and a second prompt indicating a background scene; generate, using a first image generation model, a foreground attention output based on the first prompt, wherein the foreground attention output represents the foreground object; generate, using a second image generation model, a blended attention output based on the first prompt and the second prompt, wherein the blended attention output represents the foreground object with the background scene; combine the foreground attention output and the blended attention output to obtain a combined blended attention output; and generate, using the second image generation model, a synthetic blended image depicting the foreground object in the background scene based on the combined blended attention output.

For example, after training, the machine learning model 1915 may perform inferencing operations as described with reference to FIGS. 1-4 to obtain a first prompt indicating a foreground object and a second prompt indicating a background scene; generate, using a first image generation model, a foreground attention output based on the first prompt, wherein the foreground attention output represents the foreground object; generate, using a second image generation model, a blended attention output based on the first prompt and the second prompt, wherein the blended attention output represents the foreground object with the background scene; combine the foreground attention output and the blended attention output to obtain a combined blended attention output; and generate, using the second image generation model, a synthetic blended image depicting the foreground object in the background scene based on the combined blended attention output.

Machine learning model 1915 is an example of, or includes aspects of, the corresponding element described with reference to FIGS. 3-5. In some embodiments, the machine learning model 1915 is an Artificial neural network (ANN) comprising a plurality of networks including the guided diffusion model described with reference to FIG. 7, the diffusion transformer model described with reference to FIG. 8, and the U-Net described with reference to FIG. 9. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1915 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1925 may train the machine learning model 1915. For example, parameters of the machine learning model 1915 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 16-17). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1915 can be used to make predictions on new, unseen data (i.e., during inference).

According to some aspects, training component 1925 trains the machine learning model to generate the synthetic blended image depicting the foreground object in the background scene based on the combined blended attention output. According to some aspects, training component 1925 trains the image generation model using a color channel encoder and an alpha channel encoder. According to some aspects, training component 1925 trains the variational autoencoder network using a color channel encoder and an alpha channel encoder.

According to some aspects, training component 1925 computes a loss function based on the filtered dataset (such as loss function described with reference to FIG. 16). In some examples, training component 1925 updates parameters of the machine learning model based on the loss function.

I/O module 1920 receives inputs from and transmits outputs of the image processing apparatus 1900 to other devices or users. For example, I/O module 1920 receives inputs for the machine learning model 1915 and transmits outputs of the machine learning model 1915. According to some aspects, I/O module 1920 is an example of the I/O interface 1820 described with reference to FIG. 18.

FIG. 20 shows an example of a machine learning model 2000 according to aspects of the present disclosure. Machine learning model 2000 is an example of, or includes aspects of, the corresponding element described with reference to FIG. 19. In one aspect, machine learning model 2000 includes first image generation model 2005 and second image generation model 2025.

According to some aspects, first image generation model 2005 generates a foreground attention output based on the first prompt, where the foreground attention output represents the foreground object. In some examples, first image generation model 2005 combines the foreground attention output and the blended attention output including extracting structure prior information from the first image generation model 2005. In some examples, first image generation model 2005 extracts foreground content confidence information from the first image generation model 2005. In some examples, first image generation model 2005 computes a foreground mask based on the structure prior information and the foreground content confidence information. In some examples, first image generation model 2005 combines the foreground attention output and the combined blended attention output based on the foreground mask to obtain a combined foreground attention output. In some examples, first image generation model 2005 generates a synthetic foreground image depicting the foreground object. In some aspects, the first image generation model 2005 generates images with a transparency channel.

According to some aspects, first image generation model 2005 generates the combined blended attention output including extracting structure prior information based on the foreground features. In some examples, first image generation model 2005 extracts foreground content confidence information. In some examples, first image generation model 2005 computes a foreground mask based on the structure prior information and the foreground content confidence information. In some examples, first image generation model 2005 combines the foreground features and the combined blended attention output based on the foreground mask to obtain a combined foreground attention output. In some examples, first image generation model 2005 generates a synthetic foreground image depicting the foreground object. In some aspects, a first image generation model 2005 generates images with a transparency channel.

According to some aspects, first image generation model 2005 comprises a foreground attention output based on the first prompt, wherein the foreground attention output represents the foreground object. In some aspects, the first image generation model 2005 includes a latent diffusion network 2015. In some aspects, the first image generation model 2005 generates images with a transparency channel. In some aspects, the first image generation model 2005 includes a variational autoencoder network 2010, where the variational autoencoder network 2010 is configured to generate a color channel information and the transparency channel. In some aspects, the first image generation model 2005 includes an attention layer 2020, wherein the combined blended attention output is based on an output of the attention layer 2020.

In one aspect, first image generation model 2005 includes variational autoencoder 2010, diffusion network 2015, and attention layer 2020.

Variational Autoencoder (VAE) 2010 is a type of generative model designed to learn a compact, probabilistic representation of data. VAE operates by encoding input data into a latent space, where each point represents a probability distribution rather than a deterministic feature vector. The VAE comprises two primary components: an encoder and a decoder. The encoder maps the input data to a latent distribution, typically modeled as a multivariate Gaussian characterized by mean and variance parameters. Subsequently, a latent sample is drawn from the distribution using a reparameterization trick to enable backpropagation. The decoder reconstructs the original data from this sampled latent representation.

The training objective of the VAE minimizes a combination of reconstruction error and a Kullback-Leibler (KL) divergence term to ensure the latent space distribution approximates a prior, such as a standard normal distribution. The probabilistic modeling enables the generation of new, plausible samples by sampling from the latent space. Variational autoencoder 2010 is an example of, or includes aspects of, the corresponding element described with reference to FIGS. 5-9.

Latent Diffusion Model (LDM) 2015 is a generative framework that combines latent space representation with diffusion-based noise modeling to synthesize high-quality data. LDMs first compress input data, such as images, into a lower-dimensional latent space using a pretrained encoder, such as one derived from a VAE or another compression method. The diffusion process operates in the latent space, progressively adding Gaussian noise to the latent representation with over a series of steps. The reverse diffusion process, guided by a neural network, reconstructs the denoised latent representation step by step. Finally, a decoder maps the reconstructed latent space back to the original data domain. The LDM framework significantly reduces computational overhead compared to performing diffusion directly in the high-dimensional data space, while preserving fidelity and detail. LDMs are particularly well-suited for tasks such as image synthesis, super-resolution, and inpainting, leveraging the efficiency and flexibility of latent space representations. Diffusion network 2015 is an example of, or includes aspects of, the corresponding element described with reference to FIGS. 7-10.

Attention layer 2020 is based on an attention mechanism that enables an ANN to selectively focus on different parts of an input sequence, assigning varying degrees of importance or attention to each part. The attention mechanism achieves the selective focus by considering a relevance of each input element with respect to a current state of the ANN.

An ANN employing an attention mechanism may receive an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

Calculating attention may involve three basic steps. First, a similarity between a query vector Q and a key vector K obtained from the input is computed to generate attention weights. Similarity functions used for this process include dot product, splice, detector, and the like. Next, a softmax function is used to normalize the attention weights. Finally, the attention weights are weighed together with their corresponding values V. In the context of an attention network, the key K and value V are vectors or matrices that are used to represent the input data. The key K is used to determine which parts of the input the attention mechanism should focus on, while the value V is used to represent the actual data being processed.

According to some aspects, second image generation model 2025 generates a blended attention output based on the first prompt and the second prompt, wherein the blended attention output represents the foreground object with the background scene. In some examples, second image generation model 2025 combines the foreground attention output and the blended attention output to obtain a combined blended attention output. In some examples, second image generation model 2025 generates a synthetic blended image depicting the foreground object in the background scene based on the combined blended attention output.

In some examples, second image generation model 2025 extracts blended content confidence information from the second image generation model 2025. In some examples, second image generation model 2025 computes a blended mask based on the structure prior information and the blended content confidence information, where the foreground attention output and the blended attention output are combined based on the blended mask. In some examples, second image generation model 2025 generates the blended attention output including generating background features representing the background scene. In some examples, second image generation model 2025 generates blended features representing the foreground object in the background scene. In some examples, second image generation model 2025 performs attention sharing on the background features and the blended features to obtain the blended attention output. In some examples, second image generation model 2025 generates a synthetic background image depicting the background scene.

According to some aspects, image generation model generates a combined blended attention output based on the foreground features, the background features, and the blended features. In some examples, image generation model generates a synthetic blended image depicting the foreground object in the background scene based on the combined blended attention output. In some examples, image generation model extracts blended content confidence information from the image generation model. In some examples, image generation model computes a blended mask based on the structure prior information and the blended content confidence information, where the foreground features and the blended features are combined based on the blended mask. In some examples, image generation model generates the blended attention output including generating background features representing the background scene. In some examples, image generation model generates blended features representing the foreground object in the background scene. In some examples, image generation model performs attention sharing on the background features and the blended features to obtain the blended attention output. In some examples, image generation model generates a synthetic background image depicting the background scene.

According to some aspects, second image generation model 2025 generates a blended attention output based on the first prompt and the second prompt, wherein the blended attention output represents the foreground object with the background scene. In some examples, second image generation model 2025 comprises combining the foreground attention output and the blended attention output to obtain a combined blended attention output. In some examples, second image generation model 2025 generates a synthetic blended image depicting the foreground object in the background scene based on the combined blended attention output.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a first prompt indicating a foreground object and a second prompt indicating a background scene;
generating, using a first image generation model, a foreground attention output based on the first prompt, wherein the foreground attention output represents the foreground object;
generating, using a second image generation model, a blended attention output based on the first prompt and the second prompt, wherein the blended attention output represents the foreground object with the background scene; and
generating, using the second image generation model, a synthetic blended image depicting the foreground object in the background scene based on the foreground attention output and the blended attention output.

2. The method of claim 1, wherein combining the foreground attention output and the blended attention output comprises:
extracting structure prior information from the first image generation model;
extracting blended content confidence information from the second image generation model; and
computing a blended mask based on the structure prior information and the blended content confidence information, wherein the foreground attention output and the blended attention output are combined based on the blended mask.

3. The method of claim 2, further comprising:
extracting foreground content confidence information from the first image generation model;
computing a foreground mask based on the structure prior information and the foreground content confidence information; and
combining the foreground attention output and a combined blended attention output based on the foreground mask to obtain a combined foreground attention output.

4. The method of claim 1, wherein generating the blended attention output comprises:
generating background features representing the background scene;
generating blended features representing the foreground object in the background scene; and
performing attention sharing on the background features and the blended features to obtain the blended attention output.

5. The method of claim 1, further comprising:
generating, using the first image generation model, a synthetic foreground image depicting the foreground object; and
generating, using the second image generation model, a synthetic background image depicting the background scene.

6. The method of claim 1, further comprising:
combining the foreground attention output and the blended attention output to obtain a combined blended attention output, wherein the synthetic blended image is based on the combined blended attention output.

7. The method of claim 1, wherein obtaining the first prompt and the second prompt comprises:
obtaining an input prompt describing the foreground object and the background scene; and
extracting the first prompt and the second prompt from the input prompt.

8. A non-transitory computer readable medium storing code for image processing, the code comprising instructions that, when executed by at least one processor, cause the at least one processor to perform operations comprising:
obtaining a first prompt indicating a foreground object and a second prompt indicating a background scene;
generating foreground features representing the foreground object, background features representing the background scene, and blended features representing the foreground object in the background scene;
generating, using an image generation model, a combined blended attention output based on the foreground features, the background features, and the blended features; and
generating, using the image generation model, a synthetic blended image depicting the foreground object in the background scene based on the combined blended attention output.

9. The non-transitory computer readable medium of claim 8, wherein generating the combined blended attention output comprises:
extracting structure prior information based on the foreground features;
extracting blended content confidence information from the image generation model; and
computing a blended mask based on the structure prior information and the blended content confidence information, wherein the foreground features and the blended features are combined based on the blended mask.

10. The non-transitory computer readable medium of claim 9, the code further comprising instructions that, when executed by the at least one processor, cause the at least one processor to perform operations comprising:
extracting foreground content confidence information;
computing a foreground mask based on the structure prior information and the foreground content confidence information; and
combining the foreground features and the combined blended attention output based on the foreground mask to obtain a combined foreground attention output.

11. The non-transitory computer readable medium of claim 8, wherein generating the blended attention output comprises:
generating background features representing the background scene;
generating blended features representing the foreground object in the background scene; and
performing attention sharing on the background features and the blended features to obtain the blended attention output.

12. The non-transitory computer readable medium of claim 8, the code further comprising instructions that, when executed by the at least one processor, cause the at least one processor to perform operations comprising:
generating a synthetic foreground image depicting the foreground object; and
generating, using the image generation model, a synthetic background image depicting the background scene.

13. The non-transitory computer readable medium of claim 8, wherein:
the foreground features are generated by a first image generation model based on a foreground attention output; and
the blended features are generated by a second image generation model based on a blended attention output.

14. The non-transitory computer readable medium of claim 8, wherein obtaining the first prompt and the second prompt comprises:
obtaining an input prompt describing the foreground object and the background scene; and
extracting the first prompt and the second prompt from the input prompt.

15. A system comprising:
a memory component; and
a processing device coupled to the memory component, the processing device configured to perform operations comprising:
obtaining a first prompt indicating a foreground object and a second prompt indicating a background scene;
generating, using a first image generation model, a foreground attention output based on the first prompt, wherein the foreground attention output represents the foreground object;
generating, using a second image generation model, a blended attention output based on the first prompt and the second prompt, wherein the blended attention output represents the foreground object with the background scene; and
generating, using the second image generation model, a synthetic blended image depicting the foreground object in the background scene based on the foreground attention output and the blended attention output.

16. The system of claim 15, wherein:
the first image generation model comprises a latent diffusion network.

17. The system of claim 15, wherein:
the first image generation model generates images with a transparency channel.

18. The system of claim 17, wherein:
the first image generation model comprises a variational autoencoder network, wherein the variational autoencoder is configured to generate a color channel information and the transparency channel.

19. The system of claim 15, wherein:
the first image generation model includes an attention layer, and wherein the blended attention output is based on an output of the attention layer.

20. The system of claim 15, further comprising:
a connection between a layer of the second image generation model and a corresponding layer of the first image generation model.
